(19) United States
(12) Patent Application Publication
(10) Pub. No.: US 2013/0090959 A1
(43) Pub. Date: Apr. 11, 2013

(54) RESTAURANT MANAGEMENT AND RESERVATION SYSTEMS AND METHODS

(71) Applicant: SEATME, INC., San Francisco, CA (US)

(72) Inventors: Alexander Pierre Floyd Kvamme, San Francisco, CA (US); John Edwin Doig, III, San Francisco, CA (US); Zaccariah Troy Bowling, Alameda, CA (US); Jordan Brett Mendelson, San Francisco, CA (US); Drew Rocky Domm, San Francisco, CA (US)

(73) Assignee: SEATME, INC., San Francisco, CA (US)

(21) Appl. No.: 13/647,173

(22) Filed: Oct. 8, 2012

Related U.S. Application Data
(60) Provisional application No. 61/544,250, filed on Oct. 6, 2011.

(51) Int. Cl. G06Q 50/12; G06Q 10/02

(52) U.S. Cl. 705/5

(57) ABSTRACT

A system and method for offering and managing reservations for restaurant or other reservation-based services is provided. In one embodiment, the method includes receiving reservation data regarding available reservations for restaurants, and receiving a search request and payment information from the user. A subset of the available reservations matching the search request is determined using the open reservation data. The method further includes receiving a request from a user to make a reservation corresponding to an available reservations matching the search request, storing data indicating that the requested reservation is assigned to the user, and receiving a change in status for the reservation during fulfillment of the reservation. The method also includes receiving data regarding items ordered during fulfillment of the reservation, and providing the data regarding items ordered during fulfillment of the reservation for display to the consumer on a mobile device during fulfillment of the reservation.

### CROSS-REFERENCE

This application claims the benefit of U.S. Provisional Application No. 61/544,250, filed Oct. 6, 2011, which application is incorporated herein by reference.

### BACKGROUND OF THE INVENTION

Restaurants are faced with a number of challenges in managing reservations and capacity. Restaurants face varying demand based on the day and time and a number of other factors. It may be very difficult to obtain a reservation at some restaurants while other restaurants may have empty tables. Many costs are fixed regardless of whether a restaurant is filled, such as rent and utility costs. Other costs, such as staffing and food, need to be planned in advance based on expected demand. If tables are unused or reservations are broken, restaurants may lose significant revenue that cannot be recouped. At the same time, reservation management systems that can help a restaurant manage these issues may come with their own costs. In some cases, reservation management systems may require custom hardware or software to be purchased by the restaurant and may impose reservation fees for each reservation made through the system in addition to periodic subscription fees. In addition, restaurants may need to plan for additional services beyond reservation seating, such as walk in traffic, bar seating and orders to go. Similar issues may also be faced by other entertainment or dining establishments or venues, such as night clubs, concert venues, bars and sporting events, or other reservation-based services.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a block diagram of a management and reservation system according to an example embodiment.

FIG. 2A is a block diagram illustrating additional components of a management and reservation system according to an example embodiment.

FIGS. 2B-2G illustrate example database records for databases shown in FIG. 2A according to example embodiments.

FIG. 2H is a block diagram and FIG. 2I is a flow chart illustrating an example method for dynamic pricing of premium reservations according to an example embodiment.

FIG. 2J is a block diagram and FIG. 2K is a flow chart illustrating an example method for bumping of reservations according to an example embodiment.

FIG. 2L is a flow chart illustrating an example method for dynamic restaurant capacity management according to an example embodiment.

FIG. 2M is a chart illustrating example data that may be collected and used in example embodiments.

FIG. 2N is a flow chart illustrating an example method for making reservations on a mobile client device being used by a consumer to access system 100.

FIG. 2O is a flow chart illustrating an example method for making reservations and permitting a consumer to pay for meals at a restaurant using system 100 according to an example embodiment.

FIGS. 3A-3K show example user interfaces for accessing the system on a web server according to example embodiments.

FIGS. 4A-4F and 5A-5E show example user interfaces for accessing the system using a client application according to example embodiments.

FIGS. 5F-5H show example user interfaces for restaurant management using a web interface according to example embodiments.

FIG. 6 shows an example computer architecture that may be used in connection with the system in example embodiments.

### DETAILED DESCRIPTION OF THE INVENTION

Example embodiments provide a system and method for offering and managing reservations for restaurants or other reservation-based services. In example embodiments, consumers may search for available reservations meeting their preferences, set alerts, make reservations, pay for premium reservations, receive incentives for off-peak reservations during periods of low demand, pre-pay for fixed price meals, set preferences and, in some cases, receive offers to have reservations transferred to another guest in exchange for a payment or other benefit. In example embodiments, restaurants may offer reservation inventory through the system, make available premium reservations and receive an allocation of the fees paid for premium reservations, offer discounts or incentives to encourage reservations at off peak times, permit reservations to be transferred to guests willing to pay a premium, obtain pre-payment for reservations for fixed price menus, and manage reservations and other aspects of the restaurant's operation. In example embodiments, premium reservations may be dynamically priced by the system based on demand or other criteria specified by the restaurant or service provider who operates the system. For off-peak reservations, discounts and other incentives may be offered dynamically by the system based on demand or other criteria specified by the restaurant or service provider. Example embodiments may use current and historical information regarding demand in determining dynamic pricing and discounts for reservations. Example embodiments may also interface with point-of-sale systems in a restaurant to permit payments to be made and to collect information regarding a guest's purchases and preferences at the restaurant. Example embodiments may also provide users with the ability to pay for premium positions on wait lists for walk-in traffic at restaurants, bars, night clubs and other venues or to make available premium or discounted reservations for other venues in addition to restaurants.

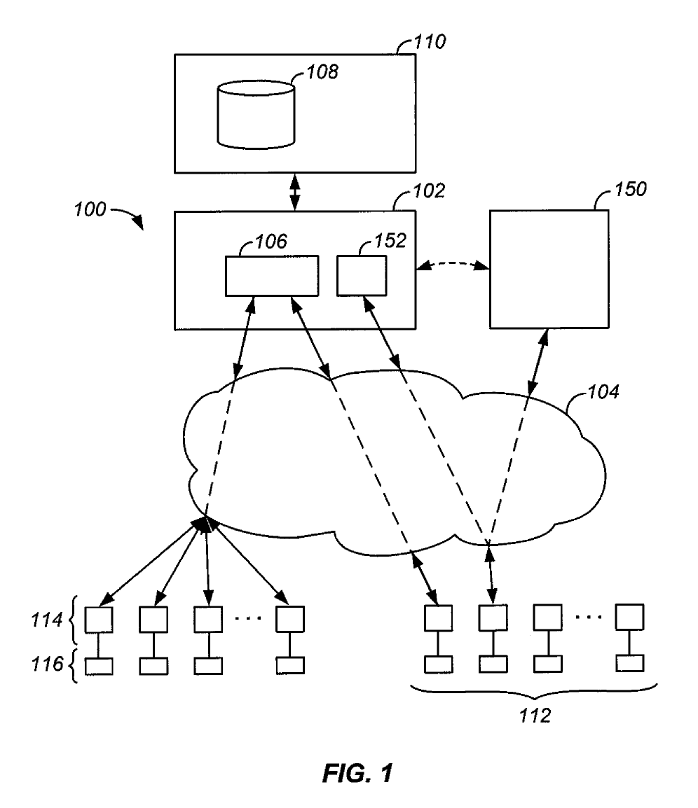

FIG. 1 is a block diagram showing a management and reservation system 100 according to an example embodiment. The management and reservation system may be provided by one or more servers 102 on a network 104, such as the Internet. Network 104 may also include wireless networks, such as cell phone networks and other wireless networks for communicating with client devices. Server 102 may be a web server on the world wide web for providing a web-based interface for accessing the management and reservation system. As shown in FIG. 1, server 102 may include one or more software applications 106. The software applications 106 may provide an interface through which users can search for available reservations at restaurants and book available reservations. Data regarding restaurants, reservations and users may be stored in one or more databases 108 in storage 110 associated with the servers. Consumers may use client devices 112 to access the management and reservation system over network 104. For example, the client devices may be a personal computer, tablet, smart phone or other device with a browser for communicating with the server. In addition, applications may be downloaded to client devices 112 to access the management and reservation system separately from the browser software. Consumers can use the web interface or application interface to search for available reservations at selected restaurants and make reservations. In example embodiments, consumers may also set alerts, pay for premium reservations, receive incentives for off-peak reservations during periods of low demand, pre-pay for fixed price meals for premium reservations, set preferences and, in some cases, receive offers to have reservations transferred to another guest in exchange for a payment or other benefit.

The user interface for the management and reservation system may also be made available from other servers and web sites that are in different domains from servers 102. For example, server 150 may be operated by a publisher of another web site, but may incorporate a software applet or widget for accessing the management and reservation system over network 104. Web pages from server 150 may include a tag for a script associated with the management and reservation system. For example, the tag may be a javascript tag on a web page served from server 150. For example, the web page may provide web pages reviewing restaurants or providing a restaurant blog or other relevant content. When the web page is downloaded, the tag is processed by the browser and the script is requested from a server, such as javascript server 152 associated with the management and reservation system. The script is downloaded by the browser and causes an interface to be displayed showing available reservations for one or more restaurants that can be selected from the browser. The applet or widget enabled by the script can be used to search and book reservations through the management and reservation system 100.

Restaurants may also use client devices for accessing the management and reservation system over network 104. In an example embodiment, the client devices are tablet computing devices 114 which include databases 116 or other files that store local copies of information from databases 108. In an example embodiment, the computing devices 114 may be a general purpose computing device such as an iPad or Android tablet computing device and do not require custom hardware to be installed by the restaurant. In example embodiments, restaurant accounts may also be accessed through a browser interface on a personal computer, tablet, smartphone or other device in order to access management features for the restaurant. In example embodiments, the client devices may be tablet computing devices that have a touch screen and a software application that provides interfaces for retrieving and entering management and reservation information for the restaurant. The application may be made available for downloading from an App Store in example embodiments. A browser based interface may also be provided.

User ids and logins for restaurant staff may be used to access the account for the restaurant. Access privileges may be set for different users to allow different levels of access. Accounts may also be established for restaurant groups, so a manager can access and enter information for a group of affiliated restaurants from a single device using a single login. In example embodiments, restaurant staff can use the application to display information about reservations and seating for the restaurant, enter new reservations, enter and manage open reservation inventory and set rules about how reservations may be offered by the server-based software application 106. In example embodiments, restaurants may also make available premium reservations and receive an allocation of the fees paid for premium reservations, offer discounts or incentives to encourage reservations at off peak times, permit reservations to be transferred to guests willing to pay a premium, and obtain pre-payment for reservations for fixed price menus.

In example embodiments, restaurants may participate in certain services and offerings on the system that provide revenue generating opportunities for both the service and the restaurant. This may allow the service to be offered to restaurants without requiring per reservation fees or other charges to be paid by the restaurant in example embodiments. For example, restaurants may agree to allow the service provider to offer a portion of its reservation inventory through the system on a premium basis, where a user is charged for booking the reservation. In some example embodiments, the restaurant may agree to allow the service provider to offer a certain number or percentage of reservations on a premium basis. The system 100 may determine which reservations require a fee or may set certain parameters or rules that govern how fees are charged for the reservations. In some example embodiments, the system may dynamically price the reservation based on information available to the system, which may include (but is not limited to) one or more of the following (or any combination of the following): the time remaining until the reservation date, the day of the week, whether it is a holiday or other special occasion, current and historical demand information for the restaurant and/or other similar restaurants for similar days or times of the year (including, for example, available seating remaining in the restaurant when the reservation is made and current availability of similar reservations at comparable restaurants in the same geographic area). In example embodiments, the consumer may provide a credit card number or other payment mechanism for securing the reservation. The reservation fee may be charged and collected by the system 100 at the time the reservation is made or upon completion of the reservation. In some example embodiments, the reservation fee is allocated between the service provider and the restaurant. The payment allocation and payment terms may be established by contract between the service provider and the restaurant at the time the restaurant's account is established. The terms of the contract may also permit the allocation to vary based on the occurrence of events, the amount of revenue realized from the restaurant's premium reservations or other factors. In some embodiments, a percentage to be retained by the service provider and a percentage to be remitted to the restaurant may be established in advance when the account is established by the restaurant. In other embodiments, a fixed portion of each premium reservation may be retained by the online service, for example a minimum amount of one dollar or some other fixed amount. Any excess amount above the fixed amount may be allocated between the service provider and the restaurant. For example, the service provider may retain 50% percent of the excess amount and remit the other 50% to the restaurant. In other embodiments, the service provider may retain only the fixed amount and remit the remainder to the restaurant.

In other embodiments, a restaurant may be charged a fee for access to the management and reservation service or to certain premium features for the service. For example, a restaurant may be charged a monthly subscription fee. A portion of the amounts collected for premium reservations or other services that generate revenue for the service provider may be credited or offset against the monthly subscription fee. For example, a portion of the reservation fee allocated to the restaurant may first be applied to the subscription fee before any amounts are paid to the restaurant. In some embodiments, the reservation fees may be retained by the service provider, but may be used as a credit against current and future subscription fees that would otherwise be charged to the restaurant.

In another example, a restaurant may obtain access to premium features by providing certain levels of premium reservation inventory. For example, portions of the reservation inventory may be in high demand, such as an 8 pm reservation on a Friday night. These portions of the inventory may be offered to consumers for a charge, and the service provider may retain a fee from these charges. Other portions of the inventory may be in low demand, such as a 4 pm dinner reservation on a Tuesday. The restaurant may want to offer discounts, reward points or other incentives to fill these reservations. In some embodiments, the service provider may charge a fee to the restaurant for filling reservations that include a discount or other incentive to be offered through the system. However, the system may also allow restaurants to use this feature without charge based on the number of premium reservations that the restaurant makes available to the system 100 or based on the amount actually collected for sales of premium reservations through the system 100 or other criteria based on the restaurant's participation in services that generate revenue for the service provider.

Other premium features of the service may also be made available without charge based on these criteria. For example, the service may allow management of affiliated restaurants through a single account as part of a restaurant group. The owner or manager of the restaurant group can manage each individual restaurant through the account as well as viewing information or configuring the service for the restaurant group as a whole or for combinations of particular restaurants in the group. The ability to manage multiple restaurants under a single account may be made available without charge to restaurant groups who agree to provide certain levels of premium reservation inventory to the system or who reach certain thresholds for sales of premium reservations through the system.

In other example embodiments, the system 100 may recommend reservations at comparable restaurants when reservations are not available at a specified restaurant selected by the user. The system 100 may also recommend reservations at restaurants in the same restaurant group when reservations are not available at a specified restaurant selected by the user. When a user books a recommended reservation, a fee may be charged to the restaurant for the recommendation made by the system to the user who was searching for a reservation at a different restaurant. However, in some embodiments, this fee may be waived or reduced based on the number of premium reservations that the restaurant makes available to the system 100 or based on the amount actually collected for sales of premium reservations through the system 100 or other criteria based on the restaurant's participation in services that generate revenue for the service provider.

In example embodiments, the use of premium reservations can provide additional sources of revenue for restaurants, reduce the likelihood of no shows and provide more certainty for planning purposes. The premium reservations also provide revenue opportunities for the service provider and support the provision of the restaurant management and reservation system to restaurants at reduced rates and without requiring per reservation fees to be paid by the restaurant for every reservation made through the system. This may be the case even though the majority of the reservation inventory in example embodiments may be made available as standard reservations without requiring reservation fees to be paid by the consumer. In example embodiments, dynamic pricing of fees for premium reservations and dynamic determination of discounts or incentives for off peak reservations also help ensure that restaurant capacity remains filled while maximizing opportunities for revenue from reservations during periods of high demand.

In some example embodiments, the system 100 may permit a user to request to pay a fee to obtain a reservation from an existing reservation holder who has already booked a reservation. The existing reservation holder may set preferences indicating that it is willing to release the reservation under certain conditions, such as the payment of a fee or for some other benefit provided by the system. In some examples, the system may release or “bump” the existing reservation if a new user is willing to pay a fee above some threshold amount. The system then allows the new user to book the reservation and provides a portion of the fee or other benefit to the original reservation holder. A portion of the fee or other benefit may also be allocated to the restaurant. In some embodiments, a benefit may be offered to the existing reservation holder to bump the existing reservation so it can be transferred to the new user. The existing reservation holder may then accept or reject the offer. In example embodiments, the reservation holder may set preferences on when and under what conditions it wants to be notified of an offer to bump the existing reservation and how the user wants to be notified of the offer.

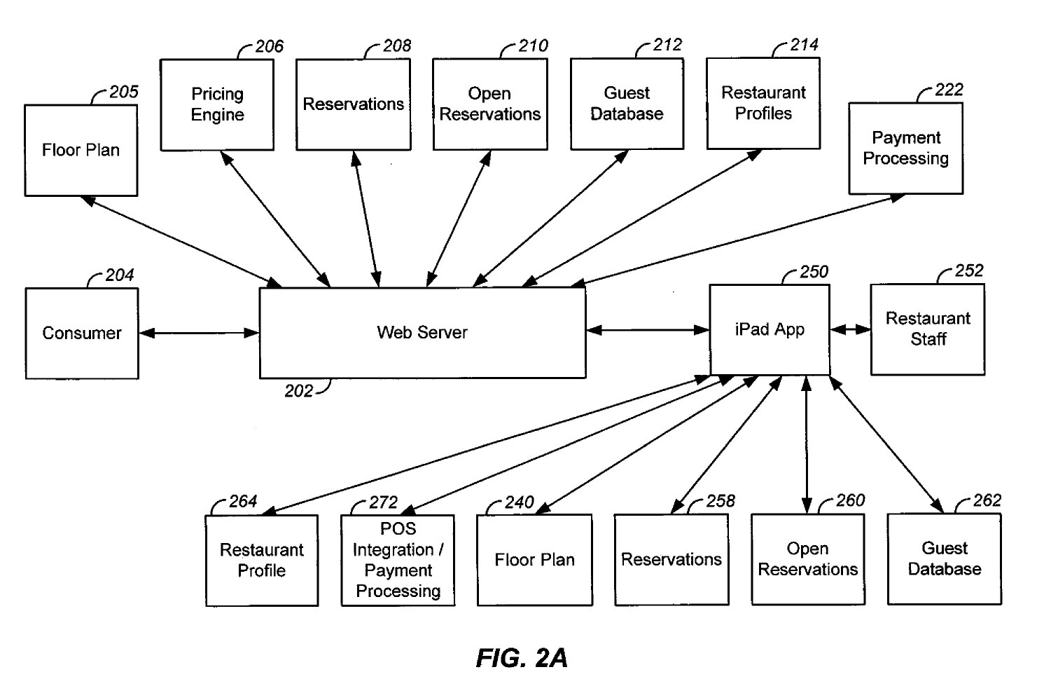

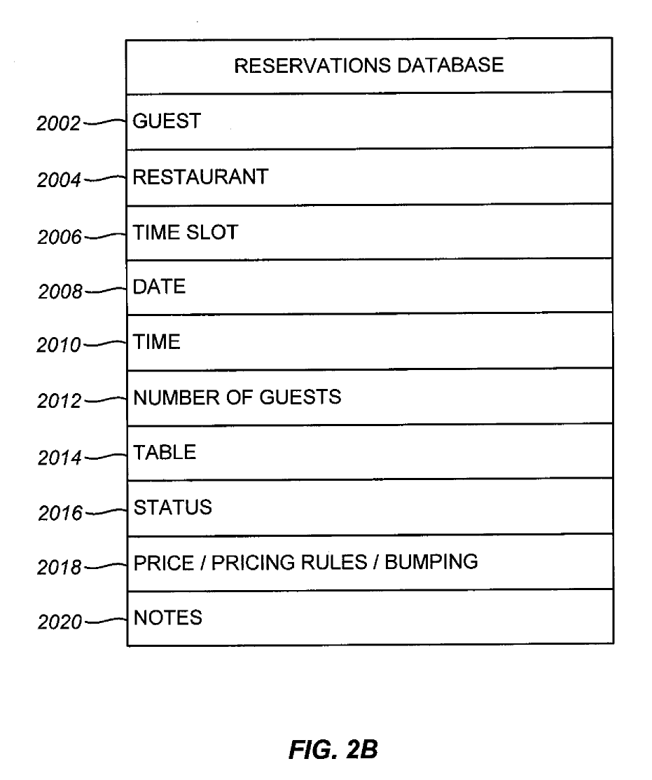

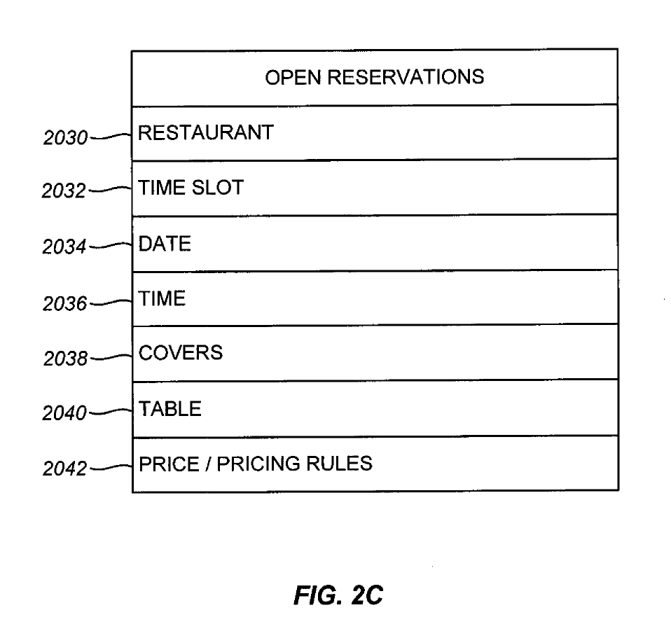

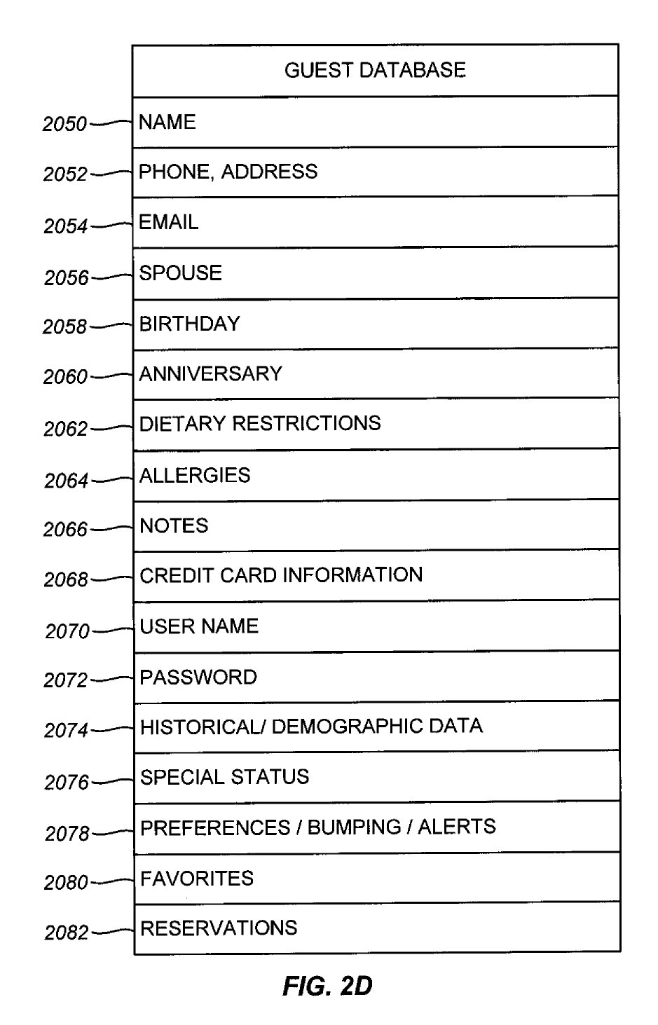

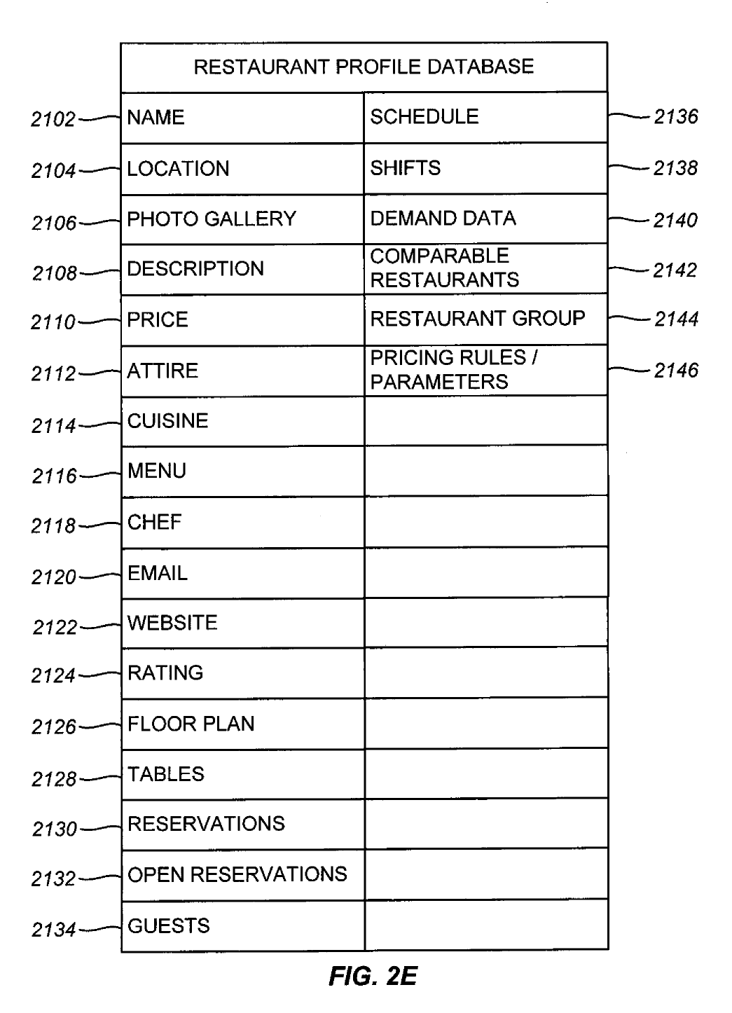

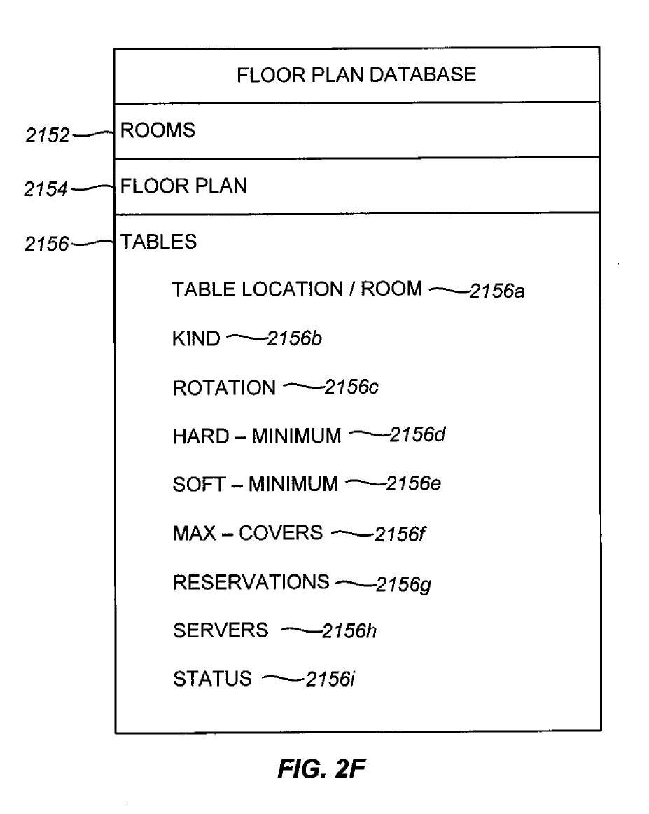

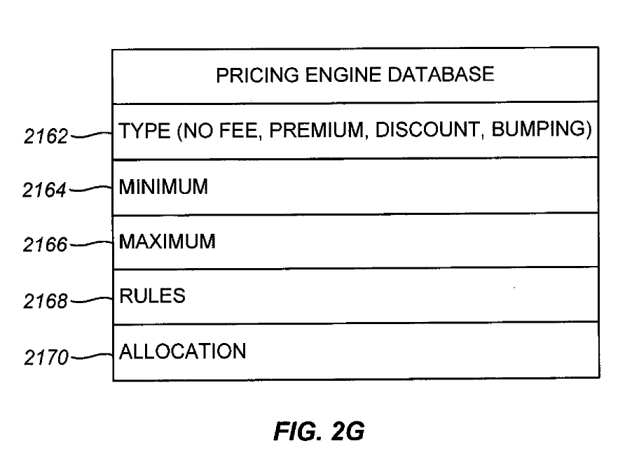

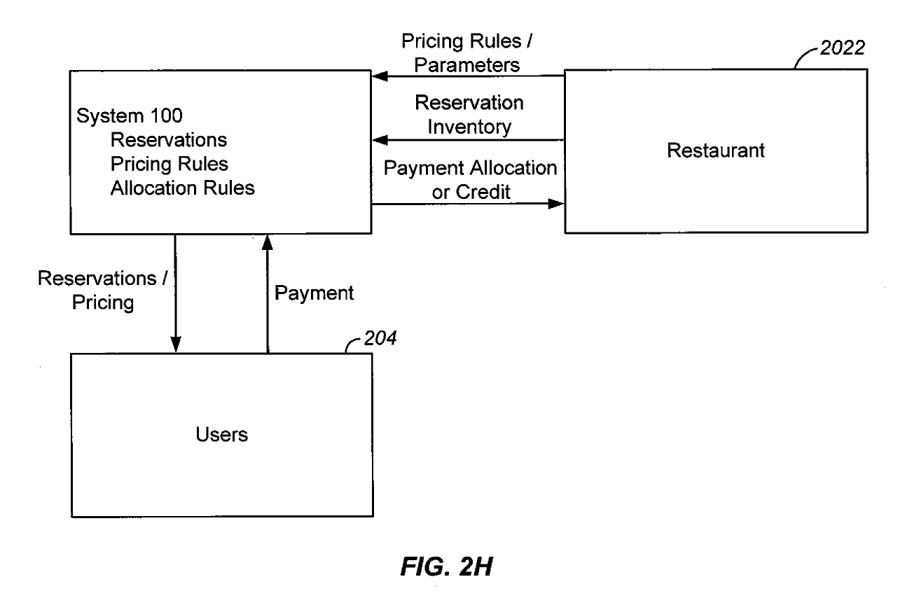

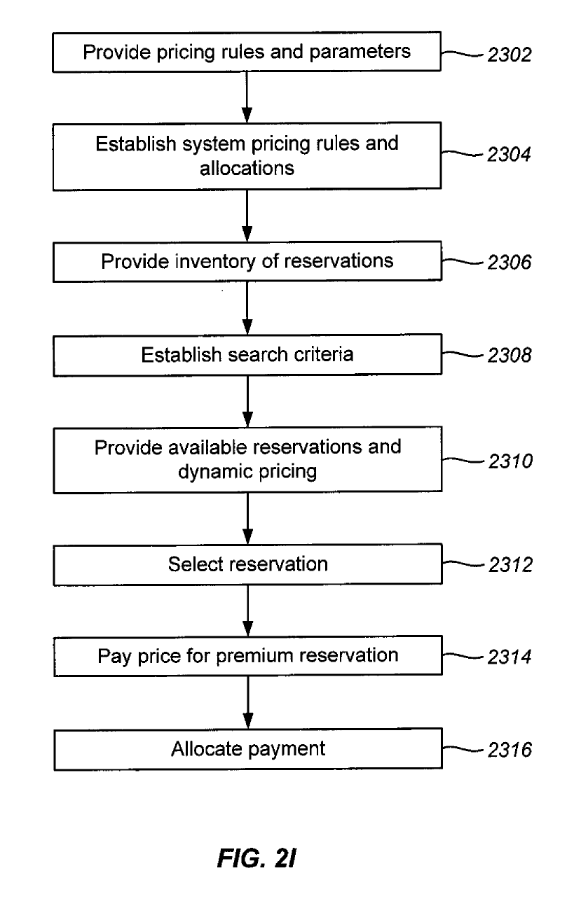

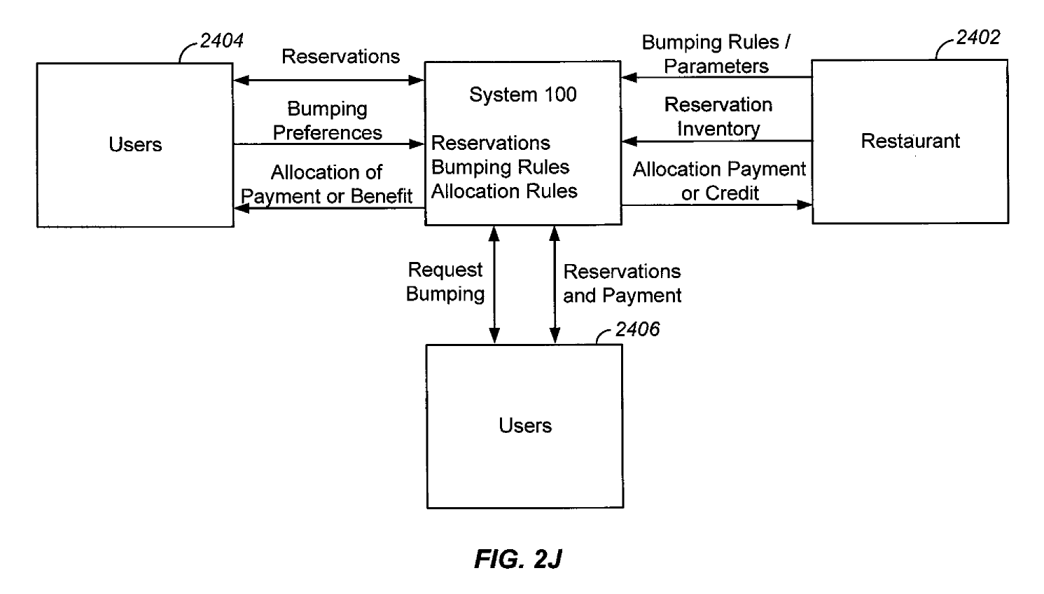

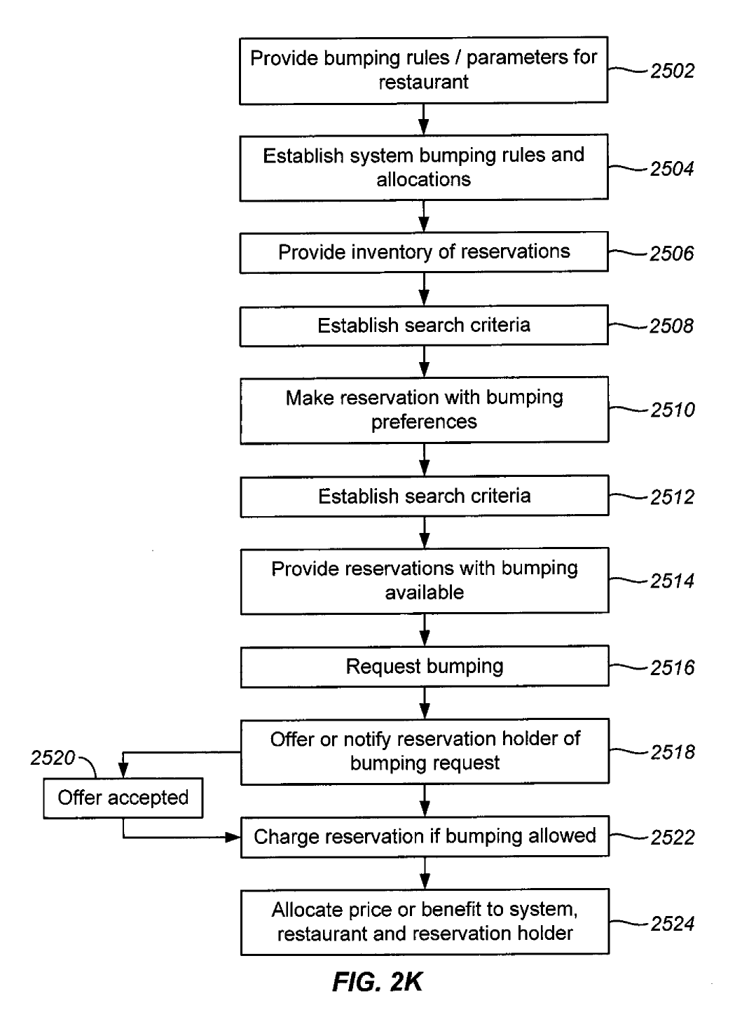

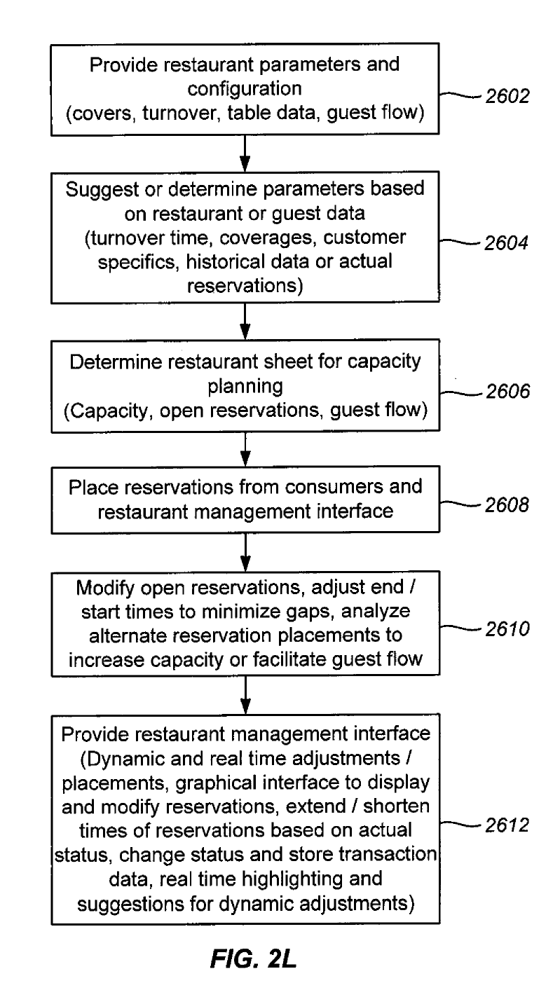

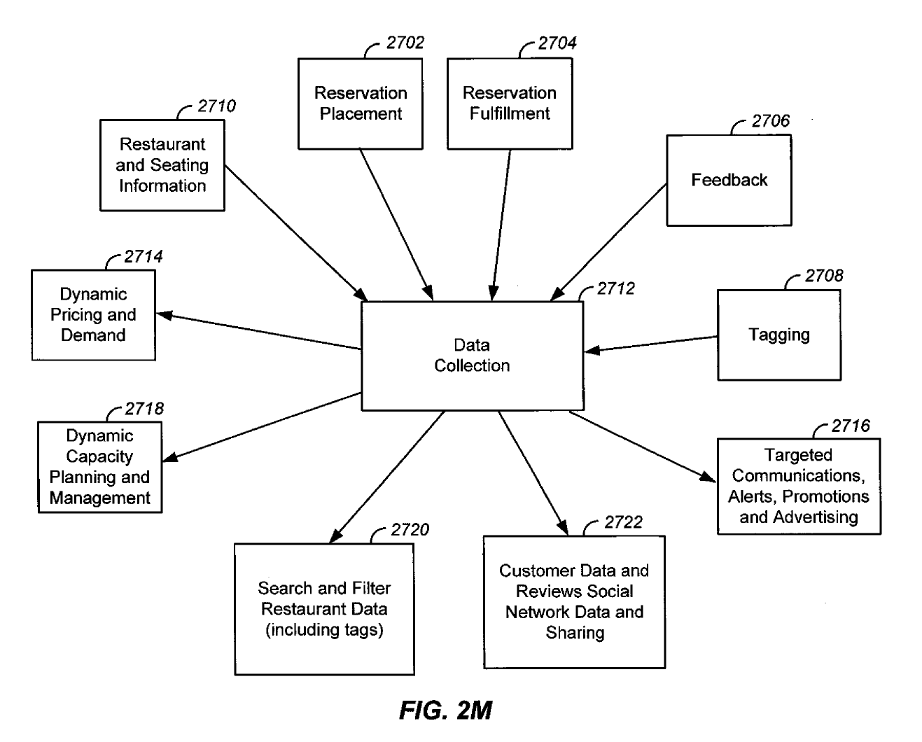

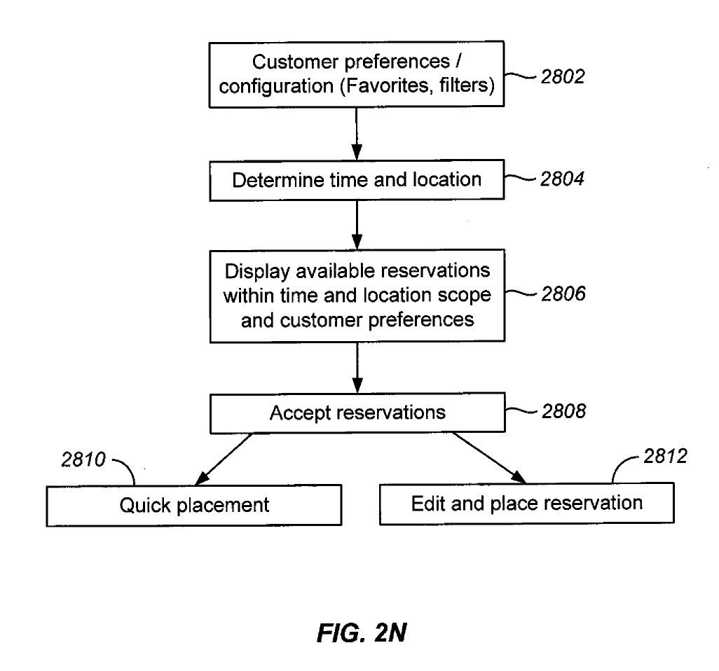

FIG. 2A is a block diagram showing additional components of a management and reservation system 100 according to an example embodiment. As shown in FIG. 2A, the management and reservation system 100 may be provided by software on web server 202. The web server 202 may be accessed by consumers 204 over the Internet using client devices, such as client devices 112 shown in FIG. 1. In this example embodiment, the software on web server 202 accesses databases for managing restaurants and reservations, including a pricing engine 206 for storing parameters and rules for determining pricing for premium reservations and other premium services, a reservations database 208 for storing information regarding reservations that have been made, an open reservations database 210 for storing information about available reservations, a guest database 212 for storing information about consumers using the service, a restaurant profile database 214 for storing information about restaurants participating in the service and a floor plan database 205 for storing information regarding the floor plan and tables for each restaurant. The web server may also include additional databases in other embodiments.

As described in connection with FIG. 1, restaurants may also access the management and reservation system 100 through client devices, such as client devices 114 shown in FIG. 1. In the example shown in FIG. 2A, the client device may be an iPad tablet computing device with an iPad software application 250 that can be downloaded from an App Store. The client device may be a general purpose computing device without requiring customer hardware to be purchased by the restaurant. The restaurant staff and management 252 may interact with the management and reservation system 100 through iPad application 250. The system 100 may have one or more user accounts for the restaurant with password protection to allow the restaurant staff and management 252 to access the application 250 and system 100. In example embodiments, a restaurant may have a general account with sub-accounts that can be used by individual staff members with different permissions and access levels. In the example embodiment, the application 250 accesses local databases or files, including a reservations database 258 for storing information regarding reservations that have been made, an open reservations database 260 for storing information about available reservations, a guest database 262 for storing information about consumers using the service, a restaurant profile database 264 for storing information about the restaurant and a floor plan database 240 for storing information regarding the floor plan and tables for the restaurant. In an example embodiment, databases 258, 260, 262, 264 and 240 may be synchronized with corresponding information in databases 208, 210, 212, 214 and 205 for the particular restaurant. In example embodiments, the local databases include information from the databases on the server for the particular restaurant, but do not include information regarding other restaurants using the service. The databases on the server, however, include data for all of the restaurants using the service.

When a reservation is made through web server 202 for a particular restaurant, the local reservations database 258, open reservations database 260 and guest database 262 may be updated to show that the reservation has been made. In addition, to ensure that the restaurant receives timely information about reservations, the web server 202 may send a request to an automated calling service (not shown) to place a telephone call to the restaurant to provide the reservation information to the restaurant so it can be entered locally by the restaurant even if there is no connection over network 104. Example embodiments may also provide notification to the restaurant by electronic mail, text messaging or other notification. Automated calling or such other notification may also be used to add a customer to a list for walk in service or to place a takeout order or for other services offered by the restaurant through web server 202. If the restaurant staff 252 enters a reservation through application 250, the reservations database 208, open reservations database 210 and guest database 212 may be updated on web server 202 in addition to storing the information in the local databases. In some embodiments, the application 250 may also access additional information stored locally for restaurant management that is not stored on web server 202.

In some example embodiments, the local application 250 may provide a module 272 for integration with a point-of-sale (POS) system used by the restaurant to manage payment transactions for the restaurant. Example embodiments interface with the POS system in a restaurant to permit pre-payments to be made for meals through the system 100. For example, premium reservations for fixed price menu meals may require a deposit or the full price of the meal to be charged in advance. A credit for this amount may be provided from system 100 to the POS system when the bill for the meal is generated. In other example embodiments, module 272 may permit a meal to be automatically charged to a credit card account entered by the consumer 204 on the system 100 (which may be stored, for example, in encrypted form in a secure data field in the guest database 212 for the consumer). In some embodiments, this data may be stored in a separate database of a POS service provider and made available through interfaces to system 100.

In some embodiments, module 272 may provide payments to be made through system 100 without integration with a separate POS system. In some embodiments, the consumer may enter payment information, such as credit card billing information, in the consumer's account on system 100. This information may be encrypted and stored in guest database 212 or another secure database. In some embodiments, web server 202 may interface with a separate payment processing service, for example PayPal or a credit card processing service, that may encrypt and store credit card information entered by the user and process payment transactions for system 100. For example, pre-paid meals or fixed price menu meals may be charged through the user's account on system 100 without using POS integration. In some of these example embodiments, a guest may be able to pre-pay for a fixed price meal so there is no requirement to pay a bill at the end of the meal or may be able to pay a bill for a meal automatically by using a pre-authorized account on system 100 without needing to wait for the server to charge a credit card. In some embodiments, module 272 may provide a user interface for restaurant staff to enter a guest's orders (food items, beverages and other items ordered by the customer). For example, the waiter may enter items ordered by the guests through the user interface. The menu items and amounts charged may then be stored in local databases as well as in a database on web server 202, such as guest database 212. The system 100 may also provide a user interface on web server 202 and/or client devices 112 (such as a mobile smartphone device, tablet computer or other mobile device) to allow a consumer to review the items ordered and amounts charged through the consumer's user account. For example, the consumer may review the restaurant bill through a web browser or a client device or through a local software application that interfaces with web server 202. For example, the user interface may be provided to the user as part of a local application running on the client device. In an example embodiment, the local application may be made available by the service provider through an App Store for a smartphone or tablet used by the consumer. In example embodiment, the consumer may review items ordered and amounts charged during the course of the meal (including to check that the order was properly entered by the wait staff) as well as for reviewing and paying the bill at the end of the meal. In example embodiments, the consumer may review and pay the bill without waiting for a physical bill to be brought to the table by the wait staff. The consumer may log into the user's account and select a user interface element (such as a tab, icon or menu item) to display the bill (including items ordered and amounts charged) on the display. The user interface may also include a user interface element for a consumer to enter a tip amount (for example, an input box for entering a tip amount) and a button or other user interface elements to confirm and/or authorize the total amount to be charged. The web server 202 may then automatically charge the customer through the payment information (such as credit billing information) consumer had previously provided for its account (or may enter alternate billing or account information). The web server 202 may include payment processing software or may interface with a separate payment processing service (for example, from another online service) to charge the authorized amount and pay the bill. The web server 202 may also apply credits, discounts or other benefits against the consumer's bill before charging the consumer's credit card. The web server 202 may then send a notification to the restaurant's account (accessible through the browser interface or interfaces on the restaurant management interface on a local application on a client device 250) to indicate that the guest has paid the bill. In example embodiments, this may also automatically change the status of the guest's reservation in the reservations databases 208 and 258 to indicate that the bill has been paid. This information can be used by the restaurant staff for capacity planning and management as described below.

In example embodiments, module 272 (whether through POS integration or an integrated payment processing module as part of system 100) may also allow information to be collected and stored in the guest database 212 or 262 (and/or in the reservations databases 208 and 258 for the particular guest's reservation or other databases) regarding a guest's purchases and preferences at the restaurant. For example, the amount spent on a meal and beverages, types of meals, wines and other items ordered and other notes and information entered by the server may be collected and stored in databases on system 100 for the particular guest. In example embodiments, this information may be used to determine whether to provide special status to the guest, add special notes to the guest's profile for future reservations, waive any premium fees for the guest for future reservations, provide priority for booking open reservations, provide credits or discounts that can be applied against future purchases at the same or other restaurants or offer other benefits or incentives to the guest. This information may also be used to award reward points or other incentives to the guest's account on system 100. In some examples, credits, discounts or other benefits may be automatically applied against the user's bill prior to payment as described above. The credits, discounts or other benefits applied may be displayed to the consumer when the consumer reviews the bill on system 100 and authorizes payment.

FIG. 2B shows an example record for a reservation in reservations database 208. These records represent reservations for a restaurant that have been booked by consumers 204. This is an example only and other embodiments may include additional tables, records or data fields for reservations. As shown in FIG. 2B, the record for each reservation may include a data field 2002 identifying the guest who made the reservation. In an example embodiment, this data field 2002 may include a pointer or index into a record of the guest database 212 for the particular guest. A data field 2004 may also be included to identify the restaurant for the reservation. In an example embodiment, this data field 2004 may include a pointer or index into a record of the restaurant profiles database 214 for the particular restaurant. A data field 2006 may also be included to identify the time slot for the reservation, including the starting time and estimated end time for the reservation. The time slot for the reservation may be established by the restaurant (for example, entered by the restaurant staff when making reservation inventory available on the system) or may be estimated by system 100 based on the typical time for a table to turnover for a reservation of similar size for a similar day/time. As described below, a number of user interfaces may be provided by application 250 to allow the restaurant staff to easily adjust the time and time slot for a particular reservation based on arrival time, the server's estimate on timing for the meal and other factors during the course of the actual reservation. Data fields 2008 and 2010 may also be included to identify the date and starting time for the reservation. A data field 2012 may also be included to identify the number of guests for the reservation. A data field 2014 may also be included to identify the table that has been assigned to the reservation. In an example embodiment, this data field 2014 may include a pointer or index into a record of the floor plan database 205 for the particular table in the restaurant. As described below, a number of user interfaces may be provided by application 250 to allow the restaurant staff to easily change the assigned table for a particular reservation to manage guest flow through the restaurant at the time of the reservation (for example based on arrival times, whether other parties at a particular table are running late or other factors). A data field 2016 may also be included to identify the status of the reservation. The status may be used by restaurant staff to help manage the reservation and seating of guests for the restaurant. For example, the status may be set as cancel/no show, expected or in-house. For guests that have arrived in-house, the status may further indicate that the party has partially arrived, all arrived, or have been paged. The reservation status may also be changed to indicate that the party has been seated or that the bill has been provided or paid. The change in status regarding billing or payment may be made automatically through the POS integration when the bill is generated or paid or may be entered by restaurant staff in example embodiments. These are examples only and other embodiments may use other status information for a reservation. A data field 2018 may also be included to identify the type and pricing parameters or rules for a reservation. For example, a reservation may be identified as a premium reservation for which a fee may be charged, a discounted reservation for which a discount or incentive is provided or a standard reservation where no fee or discount is provided. This data field 2018 may also indicate the rules or parameters to use for dynamically determining premium fees to be charged or discounts/incentives to be provided for this reservation. This data field 2018 may also be used to indicate whether bumping is permitted for this reservation and what rules or conditions apply to offers to bump the reservation in favor of another guest. In an example embodiment, this data field 2018 may include a pointer or index into a record of the pricing engine database 206 for a particular rule or rules to use in determining whether and how to charge premium fees, provide incentives or discounts or permit bumping for the reservation. In an example embodiment, when a fee has already been paid or a discount/incentive has been accepted, this data field 2018 may indicate the amount of the fee or discount/incentive rather than referencing the rules used to determine the fee or incentive/discount that was offered. A data field 2020 may also be included to store notes for the reservation, including special requests by the guest or notes or comments from the restaurant staff or notes automatically generated by system 100 based on historical information regarding the guest (for example, number of prior visits, whether the guest typically orders wine, etc.) or other information available to the system 100 about the guest or reservation (for example, whether the reservation is on or near a birthday or anniversary for the guest or dietary restrictions or other information).

FIG. 2C shows an example record for an open reservation in the open reservations database 210. These records represent available reservations for a restaurant that can be searched and booked by consumers 204. This is an example only and other embodiments may include additional tables, records or data fields for open reservations. As shown in FIG. 2C, the record for each open reservation may include a data field 2030 to identify the restaurant for the reservation. In an example embodiment, this data field 2030 may include a pointer or index into a record of the restaurant profiles database 214 for the particular restaurant. A data field 2032 may also be included to identify the time slot for the reservation, including the starting time and estimated end time for the available reservation. The time slot for the open reservation may be established by the restaurant (for example, entered by the restaurant staff when making reservation inventory available on the system) or maybe estimated by system 100 based on the typical time for a table to turnover for a reservation of similar size for a similar day/time. As described below, a number of user interfaces may be provided by application 250 to allow the restaurant staff to easily adjust the time and time slot for a particular open reservation in view of other reservations that have been made and other decisions of the restaurant staff to manage the flow of guests through the restaurant. Data fields 2034 and 2036 may also be included to identify the date and starting time for the open reservation. A data field 2038 may also be included to identify the number of covers for the reservation. This data field 2038 may include information regarding the minimum and maximum number of guests that may be accommodated by this reservation. A data field 2040 may also be included to identify the table that has been assigned to the open reservation. In an example embodiment, this data field 2040 may include a pointer or index into a record of the floor plan database 205 for the particular table in the restaurant. As described below, a number of user interfaces may be provided by application 250 to allow the restaurant staff to easily change the assigned table for a particular reservation to manage guest flow through the restaurant. In some embodiments, tables may be changed or linked together to accommodate changes in the size of the reservation or to better accommodate other reservations or requests from consumers 204 searching for reservations meeting particular criteria. For example, if open reservations are available for two tables that can be linked together, the open reservations for both tables may be linked to accommodate a request for a reservation for a larger party. A data field 2042 may also be included to identify the type and pricing parameters or rules for an open reservation. For example, an open reservation may be identified as a premium reservation for which a fee may be charged, a discounted reservation for which a discount or incentive is provided or a standard reservation where no fee or discount is provided. This data field 2042 may also indicate the rules or parameters to use for dynamically determining premium fees to be charged or discounts/incentives to be provided for this reservation. This data field 2042 may also be used to indicate whether bumping is permitted for this reservation if the reservation holder is willing to permit bumping. In an example embodiment, this data field 2042 may include a pointer or index into a record of the pricing engine database 206 for a particular rule or rules to use in determining whether and how to charge premium fees, provide incentives or discounts or permit bumping for the reservation.

FIG. 2D shows an example record in the guest database 212. These records represent a consumer 204 who uses the system 100 to search for and make reservations. This is an example only and other embodiments may include additional tables, records or data fields for guests. In an example embodiment, the data for a guest may be entered by the guest or by the restaurant staff. The guest database 212 for system 100 may have information for guests at all restaurants participating in system 100. However, the guest information that may be viewed from a restaurant's account (and which may be stored in local database 262 for the restaurant) may be limited to guests who have had or have reservations for the restaurant or who have had information entered through the account for that restaurant. In some embodiments, guest information may be made available for all guests who have had reservations or who have reservations for any restaurants in a restaurant group that is managed by the account (for example, where an account is established to manage a group of affiliated restaurants). Some information may be shared among all restaurants who can view information on a guest, such as name, phone number, email address or other information entered by the guest that would be applicable to restaurants generally. Other information may be limited to a particular restaurant's account such as notes made by the restaurant staff regarding a guest's preferences. As shown in FIG. 2D, the record for each guest may include a data field 2050 to identify the name of the guest, a data field 2052 for contact information such as phone number and address, a data field 2054 for email address and a data field 2056 to identify the spouse of the guest. The record for each guest may also include data fields to identify special occasions for the guest such as birthday 2058 and anniversary 2060. These special events may be flagged or highlighted by application 250 for the restaurant staff when viewing upcoming reservations. The record for each guest may also include data fields to identify dietary restrictions 2062 and allergies 2064. A data field 2066 may also be included for notes regarding the guest. Data fields may also be included for other tags that may be assigned to the guest, including custom tags that may be defined by the restaurant. These notes may include information entered by the guest or the restaurant staff or automatically generated by the system (for example to indicate whether the guest is a repeat customer of the restaurant or a frequent user of the system that has made more than a threshold number of reservations through the system). In example embodiments, notes entered by restaurant staff may only be viewed from the account of the restaurant or restaurant group that entered the information.

A data field 2068 may also be included for credit card or other payment information for the user. This data field may be encrypted or may be a pointer to a separate payment system with secure handling of payment transactions. In example embodiments, premium fees for reservations or pre-payments for fixed price meals or other charges may be charged to the specified credit card. In some embodiments, the credit card information or other payment information may be used with pre-approval from the user to pay for meals at restaurants. For example, this information may be provided to a POS system through POS integration 272 to pay for a meal at the restaurant.

Data fields may also be included for user name 2070 and password 2072 for the consumer's account on the system. The name and password may be used by the consumer 204 to log into system 100. Once the consumer 204 logs into the account, the consumer 204 can search for and make reservations and payments and can set or update data and preferences that are stored in the guest database for that account.

The record for each guest may also include one or more data fields 2074 for storing historical and demographic information that is collected regarding the guest. For example, information regarding prior reservations and transactions by the guest may be stored, including number of cancelations or no shows. In example embodiments, this information may be used to determine whether to provide special status to the guest, waive fees for premium reservations for the guest, close the guest's account, make promotional offers or provided discounts or incentives or take other actions based on information about the guest and past reservations and transactions conducted by the guest. A data field 2078 may be used to identify special status for the guest, such as whether the guest is a frequent customer, valued customer based on past purchases, or investor, food critic or other person with special status. One or more data fields 2078 may also be included to set preferences for the guest's account, including whether and under what conditions the guest is willing to receive requests for bumping, alerts that have been established by the guest for particular reservations when they become available (and preferences for how those alerts should be sent) or other settings established by the consumer 204 for the account. A data field 2080 may also be included to identify lists of restaurants that have been identified as favorites or otherwise grouped by the consumer for purpose of searching for reservations among those restaurants. One or more data fields 2082 may also be included to identify reservations for the guest, which may include past reservations, canceled reservations and upcoming reservations. In an example embodiment, this data field 2082 may include pointers or indices into records of the reservations database 208 for reservations for the particular guest.

FIG. 2E shows an example record in the restaurant profile database 214. These records represent a restaurant for which reservations are made available on system 100. This is an example only and other embodiments may include additional tables, records or data fields for restaurants. As shown in FIG. 2E, the record for each restaurant may include data fields identifying the name 2102 and location 2104 of the restaurant. A data field 2106 may also include a pointer to a photo gallery containing photos of the restaurant that can be displayed on the restaurant's profile page. Other data fields may include additional information regarding the restaurant that can be displayed on its profile page and used to match against search criteria, including description of the restaurant 2108, typical price range of the restaurant 2110, attire 2112, type of cuisine 2114 and rating 2124. A data field 2116 may also include a pointer to a menu for the restaurant that can be viewed from the restaurant's profile page. In some embodiments, items or choices may be pre-selected from the menu when a reservation is made. Data fields are also included identifying the chef 2118, email address 2120 and web site address 2122 for the restaurant 2122. A data field 2126 is also included to identify the floor plan for the restaurant. In example embodiments, this data field 2126 may include a pointer or index into a record of the floor plan database 205 for the particular restaurant. A data field 2128 is also included to identify the tables in the restaurant. In example embodiments, this data field 2128 may include a pointer or index into data fields in the floor plan database 205 for tables in the restaurant. A data field 2130 is also included to identify the reservations that have been made for the restaurant. In example embodiments, this data field 2130 may include pointers or indices into records of the reservations database 208 for reservations for the particular restaurant. A data field 2132 is also included to identify open reservations that are available for the restaurant. In example embodiments, this data field 2132 may include pointers or indices into records of the open reservations database 210 for available reservations for the restaurant. A data field 2134 is also included to identify guests for the restaurant. In example embodiments, this data field 2134 may include pointers or indices into records of the guest database 212 for guests who have made reservations for the restaurant. In this example, data fields are also included to identify the schedule 2130 and shifts 2138 for the restaurant. This information can be used by restaurant staff as part of application 250 to view and manage information for different schedules and shifts in the restaurant.

One or more data fields 2140 may also be included to identify demand information for the restaurant. This information may include historical information and statistics regarding demand for reservations at the restaurant and at comparable restaurants. Comparable restaurants may be identified in data field 2142 (and may be used to help estimate demand or to make recommendations when reservations are not available at a specified restaurant). The demand data 2140 for the restaurant may include information based on the time of reservation, day of week, time of year, proximity to specified holidays or special events or other criteria affecting demand. Data may be included for similar times/days in the prior year or for similar times and day of week in preceding weeks or months. Data may also be included regarding the number of open reservations for the same or adjacent time slots on the same day in the particular restaurant or in comparable restaurants of similar type in the same geographic area. Data may also be included regarding the number of searches that have been made or booked on the system 100 based on criteria that would match particular open reservations. Each item of data regarding demand for the restaurant may be referenced and used to dynamically establish pricing or incentives/discounts to offer for particular reservations. The pricing engine database 206 may be used to specify which data items to use to estimate demand and the weighting to be applied to each data item in determining an overall estimate for demand for a particular reservation. The particular rules to use for determining pricing or incentives/discounts to offer for particular reservations for the restaurant may be identified in data field 2146. In example embodiments, this data field 2146 may include pointers or indices into records of the pricing engine database 206 to be used for the restaurant.

FIG. 2F shows an example record in the floor plan database 205. These records represent the floor plan and tables for a restaurant. This is an example only and other embodiments may include additional tables, records or data fields for floor plans and tables for restaurants. As shown in FIG. 2F, the record for the floor plan for each restaurant may include a data field identifying the rooms 2152 in the restaurant. Each room 2152 may have an associated floor plan 2154. The floor plan 2154 may include data for graphically displaying the table layout of the room for the restaurant. This information may be used to generate a floor plan view of the restaurant as described below. Each floor plan 2154 may be associated with a group of tables 2156. Each table record 2156 may include a data field identifying the location 2156a of the table, which may include both the room and location in the room where the table is located in the floor plan. Each table record 2156 may also include a data field 2156b specifying the kind of table and rotation 2156c for the table to be used for displaying the table on the graphical floor plan interface (described further below). Each table record 2156 may also include a data field 2156d indicating a hard minimum on the size of a party for which the table may be reserved and a data field 2156e indicating a soft minimum with the preferred minimum size of the party for the table. A data field 2156f may indicate the maximum covers for the table which indicates the maximum number of guests that can be accommodated at the table. This information may be used to determine whether a particular reservation can be assigned to the table. A data field 2156g is also included to identify the reservations that have been assigned to the table. In example embodiments, this data field, 2156g may include pointers or indices into records of the reservations database 208 for reservations that have been assigned to the respective table. A data field 2156h may also be included to identify the server assigned to the table for different shifts. A data field 2156i may also be included to identify the status of the table at a given time. For example, the status may indicate that the table is unoccupied at a particular time or is occupied by guests for a particular reservation that has been assigned to the table.

FIG. 2G shows an example record in the pricing engine database 206. These records represent rules or parameters that can be used by the system 100 to dynamically determine pricing or incentives/discounts to offer for particular open reservations. In example embodiments, the fee charged may be a fee charged for booking the reservation or may include a pre-payment for a meal or may include an advance charge for a fixed price menu meal. The amounts charged for each of the fees can be varied dynamically based on rules established in the pricing engine database. Each record may be referenced by one or more open reservations that use the rule to determine whether and how to price or discount the reservation (or pre-payments for a meal associated with the reservation). Existing reservations may also reference rules in the pricing engine database 206 to determine whether and under what conditions to permit bumping of an existing reservation. This is an example only and other embodiments may include additional tables, records or data fields for rules and parameters for pricing, discounts/incentives and bumping. As shown in FIG. 2G, a data field 2162 is included to specify the type of rule established by the record. In example embodiments, the type may specify that no fee should be charged (in which case, the remainder of the record may be omitted), that a premium fee should be charged for the reservation if the conditions in the rule are satisfied, that a discount or incentive should be offered if the conditions in the rule are satisfied or that bumping should be permitted for an existing reservation if the conditions in the rule are satisfied. Data fields 2164 and 2166 may also be included to establish a minimum and maximum pricing that may be charged for a premium reservation, the minimum and maximum discounts/incentives that may be offered for a discounted reservation or the minimum and maximum amounts that may be charged for bumping a reservation. The rules to be used may be specified in data field 2168. In some examples, the rules may simply specify a price to be charged based on the demand for reservations for the particular day and time. In other embodiments, the rules may reference any other data fields available to system 100. For example, the rules may reference demand data 2140 regarding open reservations for a particular restaurant. A weighting may be assigned to each data item referenced in the rule. The values obtained from the weighted data values may then be assigned to different pricing or discounting outcomes. For example, if the resulting value reflects a high level of demand with significant time left until the reservation occurs, then a higher premium may be charged. On the other hand, if a number of reservations remain open and only a few days remain until the reservation occurs, then no fee may be charged. In example embodiments, the rules used for dynamically pricing reservations may include (but are not limited to) one or more of the following (or any combination of the following): the time remaining until the reservation date, the day of the week, whether it is a holiday or other special occasion, current and historical demand information for the restaurant and/or other similar restaurants for similar days or times of the year (including, for example, available seating remaining in the restaurant when the reservation is made and current availability of similar reservations at comparable restaurants in the same geographic area). In example embodiments, the rules may be evaluated dynamically when a search for open reservations is made. In other embodiments, the pricing is only updated periodically (for example, once an hour or once a day).

Similarly, rules may be established using the above factors to determine whether to offer a discount or incentive for a user to book a particular reservation. A gift certificate of a particular amount to be used at the restaurant at the time of the reservation or a percentage discount to be applied to the meal may be specified. Other incentives, such as award points toward free or discounted meals or other incentives may also be offered.

Rules may also be established for bumping an existing reservation. Bumping refers to releasing a booked reservation so it can be booked by another guest who has requested the reservation. In example embodiments, the guest who initially made the reservation must specify that requests for bumping will be permitted. The rule may then be used to determine whether to make bumping available, for example if no other reservations are available for the requested time slot and an existing reservation holder indicated that requests for bumping will be considered.

Other rules or conditions may also be established. For example, some reservations may be for fixed price meals. Instead of requiring a reservation fee to be paid, these reservations may require pre-payment of the fixed price for the meal in order to hold the reservation if the conditions of the rule are satisfied. For example, high demand reservations, such as dinner on certain holidays, may require pre-payment.

The rules may also specify how to handle canceled reservations. For example, cancellations with sufficient advance notice may receive a refund of the fee charged for the reservation or pre-payment of the meal. Cancellations on shorter notice may receive only a credit for future use at the restaurant or may not receive a refund or credit. In some cases, pre-paid meals may receive a partial refund, but a cancellation fee may be charged. In some cases, whether a refund or credit is provided will depend upon the number of times that reservations have been cancelled or there have been no shows by the same guest in the past. In some cases, a charge may be applied for a missed reservation or for a change in party size that shows up for a reservation relative to the size of the reservation.

The records in the pricing engine database 206 may also include allocation rules for allocating a reservation fee between the service provider who operates system 100 and the restaurant. In some example embodiments, the reservation fee is allocated between the service provider and the restaurant based on the specified allocation rules 2170. In some embodiments, the allocation may vary based on the occurrence of events, the amount of revenue realized from the restaurant's premium reservations or other factors. In some embodiments, a percentage to be retained by the service provider and a percentage to be remitted to the restaurant may be established in advance when the account is established by the restaurant. In other embodiments, a fixed portion of each premium reservation may be retained by the online service provider, for example a minimum amount of one dollar or some other fixed amount. Any excess amount above the fixed amount may be allocated between the service provider and the restaurant. For example, the allocation rules may specify that the service provider will retain 50% percent of the excess amount and remit the other 50% to the restaurant. Other allocation rules may specify that the service provider will retain only the fixed amount and remit the remainder to the restaurant. These are examples only and other allocation rules may be established for allocating reservation fees between the service provider and the restaurant. In some example embodiments, portions allocated to the restaurant may also be applied as a credit against other charges.

The allocation rules 2170 may also specify rules for allocating payments received for bumping. In example embodiments, the rules may specify a portion of the fee to be retained by the service provider, a portion to be provided to the restaurant and a portion to be provided to the original reservation holder. In other examples, the original reservation holder may receive a gift certificate or credit at the restaurant or some other benefit and the payment for bumping may be allocated between the online service provider and the restaurant. In some example embodiments, portions allocated to the restaurant may also be applied as a credit against other charges.

The data fields for the pricing engine database may be entered by the service provider or may be entered by authorized restaurant management from the restaurant's account on the system. In some example embodiments, restaurants may be permitted to set selected parameters, such as the minimum and maximum prices for a reservation and a percentage or volume of reservations that may be charged as premium reservations. The service provider may then establish dynamic pricing rules to determine premium fees within those parameters based on demand data and other information available to system 100.

FIG. 2H shows a block diagram and FIG. 21 shows a flow chart illustrating an example method for dynamically pricing and allocating payments for premium reservations according to an example embodiment. A restaurant 2202 may provide pricing rules and parameters to system 100 as shown at step 2302 in FIG. 21. In some example embodiments, the restaurant may provide the pricing rules that may be used for particular reservations. In other embodiments, the restaurant only provides a limited number of parameters and the system provider determines what rules to use for dynamic pricing within those parameters. For example, the restaurant may provide parameters indicating which reservations may be premium priced (for example, based on days and time slots) and the percentage or number of reservations that may be premium reservations. The restaurant may also indicate that reservation fees cannot be charged until a certain threshold level or percentage of reservations have been booked within specified times slots or that reservation fees cannot be charged if the time remaining until the time of the reservation is less than a threshold amount. The restaurant may also indicate a maximum amount that can be charged for a premium reservation. In example embodiments, the system 100 may also use historical data, benchmarks or other data available to the system (for example, from databases 108) to suggest parameter settings for any of the above or other parameters to the restaurant and allow the restaurant to accept or modify the parameter setting. Each of these parameters may be reflected in rules included in the pricing engine database 206 for reservations meeting the criteria specified by the restaurant. The service provider may then establish more specific rules in the pricing engine database 206 to dynamically price reservations within these parameters as shown at step 2304 in FIG. 21. The service provider may also establish allocation rules in the pricing engine database 206 based on the agreement reached with the restaurant about how reservation fees will be allocated between the service provider and the restaurant. The restaurant will also provide an inventory of open reservations as shown at step 2306 in FIG. 21. Records are stored in the open reservation database 210 for each of the open reservations provided by the restaurant. The open reservations that are identified as premium reservations will reference the records in the pricing engine database 206 with the rules for dynamic pricing and allocation. A consumer 204 can then perform a search for available reservations based on specified search criteria (such as restaurant, date, time and size of party) as indicated at step 2308. System 100 then retrieves open reservations from open reservations database 210 that meet the search criteria and dynamically determines whether a reservation fee will be required for each open reservation and the amount of the fee, as indicated at step 2310 in FIG. 21. When the reservations are displayed on the search results page, the amount of the fee that was calculated for the open reservation is displayed. The consumer 204 can then select a reservation to book from the search results as indicated at step 2312 in FIG. 21. If the reservation had a reservation fee indicated, the consumer then pays the reservation fee as indicated at step 2314 in FIG. 21. For example, a credit card account provided by the consumer may be charged for the reservation fee at the time the reservation is booked. A record is then established in the reservations database 208 for the reservation that has been booked and the open reservation for that time slot is removed from the open reservations database 210. System 100 then allocates a portion of the reservation fee to the restaurant in accordance with allocation rules specified in the pricing engine database 206 as indicated at step 2316 in FIG. 21.

FIG. 2J shows a block diagram and FIG. 2K shows a flow chart illustrating an example method for bumping reservations according to an example embodiment. A restaurant 2402 may provide bumping rules and parameters to system 100 as shown at step 2502 in FIG. 21. In some example embodiments, the restaurant may provide the bumping rules that may be used for particular reservations. In other embodiments, the restaurant only provides a limited number of parameters and the system provider determines what rules to use for bumping within those parameters. For example, the restaurant may specify only whether bumping is permitted for particular reservations or groups of reservations and the system 100 may determine when and how to make bumping available for those reservations as indicated at step 2504 in FIG. 2K. The service provider may also establish allocation rules in the pricing engine database 206 based on the agreement reached with the restaurant about how payments for bumping will be allocated between the service provider, restaurant and original reservation holder. The restaurant will also provide an inventory of open reservations as shown at step 2506 in FIG. 2K. Records are stored in the open reservation database 210 for each of the open reservations provided by the restaurant. A user 2404 can then perform a search for available reservations based on specified search criteria (such as restaurant, date, time and size of party) as indicated at step 2508. A reservation can then be made by a user 2404 as shown at step 2510 in FIG. 2K. If the reservation holder has indicated that it will consider requests for bumping, then the reservation may reference the rule established for bumping in the dynamic pricing database 206. Another user 2406 may then use the system to search for available reservations as shown at step 2512 in FIG. 2K. If open reservations are not available for a particular time slot, but existing reservations that permit bumping are available, the system may display those reservations in the search results as indicated at step 2514 in FIG. 2K. The user may then select one of those reservations indicating that the user is willing to pay the specified amount for the reservation as indicated at step 2516. Alternatively, the system may not specify a price for bumping and rather may permit the user to specify an amount the user would be willing to pay for the reservation. The system 100 may then notify the existing reservation holder of the request for bumping as indicated at step 2518. The bumping preferences that were established by the reservation holder may indicate how and when notices of bumping requests may be provided. The notice may include an amount that would be allocated to the existing reservation holder if the request for bumping is accepted. In an example embodiment, the existing reservation holder is not notified of amounts that may be retained by the service provider or restaurant. If the existing reservation holder accepts the request as indicated at step 2520, the existing reservation is released and assigned to the new user. The new user is charged the fee for bumping as indicated at step 2516. As shown at step 2518, the system 100 then allocates the payment among the service provider, restaurant and original reservation holder based on the allocation rules in the pricing engine database.

In example embodiments, the system 100 may also provide software modules and interfaces for managing restaurant capacity and reservations dynamically. In example embodiments, system 100 may coordinate booking and placement of advance reservations (from both consumers booking reservations through web server 202 and from restaurants through a restaurant management interface on client device 250 or a web interface to server 202) as well as modifications of reservations as guests actually arrive in the restaurant. FIG. 2L is a flow chart illustrating an example method for dynamic restaurant capacity management according to an example embodiment. As shown at step 2602, a restaurant may provide restaurant parameters and configuration data that can be used for capacity management. This data may be entered through the interface on client device 250 or through a web interface to web server 202. This data may include table information, including floor plan layout, number of table, minimum and maximum covers at a table and other data stored in the floor plan database 205, restaurant profiles database 214 and/or open reservations database 210 or other data to be used for capacity planning and reservation placement. In an example embodiment, the data entered by the restaurant may include the number of covers (number of guests that can be accommodated) for the restaurant, each room and/or each table (and may include “soft” preferred minimums and maximums as well as hard minimums and maximums), other table data, estimated turnover times for parties of different sizes (which may also vary by meal and time) and guest flow parameters. Guest flow parameters may include the number of parties and total number of guests that can be seated in a given time interval. For example, a restaurant may establish that no more than 4 parties and a maximum of twenty guests may be seated during each 15 minute interval. “Soft” preferred maximums and hard maximums may also be set for these parameters. These parameters can then be used to spread reservations over time intervals to smooth out the flow of guests arriving at the restaurant to be seated. These are examples only and other embodiments may allow other parameters to be set through the restaurant's account to manage capacity.

As shown at step 2604, parameters may also be suggested or determined automatically by system 100 (for example, by software operating on web server 202 and/or client device 250). In an example embodiment, the parameters suggested or determined by system 100 may be determined based on data in databases 108 regarding the restaurant or particular guests or historical data. For example, estimated turnover times may be based, at least in part, on historical data regarding actual turnover time at the restaurant for similar party sizes at similar times on similar days. Historical data regarding turnover time at similar restaurants may also be used to estimate turnover. This data may be collected through the restaurant management interface by storing the times when restaurant staff indicate that a party has been seated and when the reservation is complete (whether entered manually or by integration with POS or other systems indicating that the bill has been paid or by an indication that the table is open or another reservation has been seated at the table or otherwise). Parameters may also be configured to be determined based, at least in part, on the particular guest who is booking a reservation. Historical data regarding the turnover time for the guest on similar meals with similar party size can be used as a factor for estimating the turnover time to allow for a respective reservation for that guest. In example embodiments, averaged data (for a particular restaurant or across restaurants), customer specific data and/or restaurant specified parameters may be combined to suggest or determine parameter values such as turnover time or other data to use for capacity management. For suggested parameters, the system 100 may display the suggestions to the restaurant management through the restaurant management interface, which may then be edited and saved with values accepted by the restaurant. These are examples only and other embodiments may allow other data to be used in suggesting or determining parameters to use for capacity management.

As shown at step 2606, the system 100 may then determine a restaurant “sheet” to be used for capacity planning and management. The sheet is a set of data to be used in determining reservations and capacity management for the restaurant and may be printed as a timeline of available reservation slots for tables in the restaurant or displayed in other formats described below in connection with the restaurant management interface. This may include the parameters from steps 2602 and 2604 and capacity related data generated from those parameters. For example, the data may include the capacity for the restaurant and tables, guest flow parameters, and an inventory of open reservations to be made available in open reservations databases 210 and 260 based on those parameters which will utilize the restaurant's capacity while also providing a smooth guest flow as guests arrive to be seated based on the guest flow parameters.

As shown at step 2608 reservations may then be booked by consumers 204 through web server 202 or by the restaurant staff through client device 250 or other interface to the restaurant's account on system 100 as described above. As reservations are booked, they are entered in reservations databases 208 and 258 and removed from the open reservations databases 210 and 260. Reservations placed by consumers online and by restaurant staff through the restaurant management interface are synchronized on a real time basis through the use of these databases and the software on web server 202 and client device 250.

As shown at step 2610, the system 100 (through software on web server 202 and/or client device 250) may then modify the sheet for the restaurant or modify open reservations based on the reservations that have actually been made. For example, the start and end times for adjacent (prior or subsequent) open reservations may be automatically adjusted to eliminate or reduce gaps between reservations. The start times for open reservations may also be adjusted to facilitate guest flow based on the guest parameters and the actual reservations that have been made that start during each time interval. Example embodiments may also generate alternative placements for reservations and open reservations (for example, by changing assigned tables for reservations and/or by changing start and end times for open reservations) to increase available capacity and/or improve guest flow. For example, system 100 may initially place reservations at tables that do not cause the “soft” preferred maximum covers for a table to be exceeded. However, as the restaurant fills up, the system 100 may change table assignments to exceed the soft maximum (but still be within the hard maximum) to open up capacity for additional reservations. The alternative reservation placements can be evaluated against both capacity utilization and balance of guest flow to select the table placements to be used for the reservations in the reservations databases.

As shown at step 2612, software and interfaces (on web server 202 and/or client device 250) may also be provided to allow restaurant staff to dynamically change reservations through the restaurant management interface. These changes may override the recommendations for reservation placement that were automatically established by system 100 in advance. For example, in some embodiments, once a seating or shift at the restaurant has started, the restaurant staff may control placement of reservations at tables and modifications and changes in status for a reservation. In some examples, reservation requests from web server 202 may still be displayed through the restaurant management interface (for example as a graphical icon for a reservation request as described below) with highlighted open reservations that could accommodate the request. However, the restaurant staff may actually place the reservation at a table in real time (for example, as described below by dragging the icon for the reservation to an available table). The restaurant staff may also move start times and end times or other aspects of the reservations based on the actual times of arrival and departure of the party. The restaurant staff may also modify the status of reservations as guests arrive to be seated (for example, by indicating the party is waiting to be seated, has been seated, is on appetizers, entrees or dessert, has received the bill, has paid or has left) or data provided by other systems (like POS integration) may be used by the system 100 to automatically change the status. The actual menu items ordered, prices paid and tips may also be collected and stored in some example embodiments. This data can then be used for subsequent dynamic pricing, capacity management or planning or other purposes as described further below.

FIG. 2M is a chart illustrating example data that may be collected and used in example embodiments. As shown at FIG. 2702, data regarding reservations that have been placed through the system 100 may be collected and stored in databases 108 (as indicated at 2712). This may include any of the reservation data described above or other information regarding reservations or the guests placing the reservations. As shown at 2704, data regarding the fulfillment of the reservation may also be collected and stored in databases 108. For example, this data may include start and end times for reservations or other data regarding the reservations based on the actual fulfillment. For example, missed reservations, late arrivals, having a smaller party than the reservation size, turnover time, actual menu items ordered, prices paid for food items and beverages and tips and other data may be collected and stored.

In example embodiments, feedback and ratings may also be collected by guests regarding their experience as indicated at 2706. For example, when a reservation is indicated as completed (for example, when the bill has been paid or restaurant staff indicates the table has been vacated), system 100 may send a text message or other notice to the user at that time or within some time interval (such as 30 minutes, an hour or within 24 hours or other time interval). The message may thank the user for visiting the restaurant and solicit a short (for example, yes/no) response as to whether the visit was satisfactory. Feedback may also be solicited through the user's account through the web interface. System 100 may also request a longer survey or feedback periodically (for example, one out of every 5 reservations or some other selection parameter) or based on user preferences as to whether they wish to receive requests for feedback. Benefits may also be provided to users who provide feedback including discounts, waiver of reservation fees, loyalty points and the like.

As indicated at step 2710, data regarding the restaurant or seating for reservations may also be stored. For example, this could include the menu items available at the time of the reservation which can be stored in association with the reservation information and feedback for guests who visited the restaurant during that time. As shown at 2708, tagging may also be provided. Tags may be submitted for reservations, restaurant information or other data to be used for filtering and sorting. Restaurants may define custom tags to assign or associate with any of the data records in databases 108, such as reservations, guests, restaurant information regarding particular dates or seatings and the like. For example, a restaurant may create a tag for a special event (like a fundraiser or wine tasting at the restaurant) and apply the tag to guests who participated in that event.

As shown at 2714, the data collected may be used for dynamic pricing decisions (for example, by defining rules that reference the data items as described above). For example, a guest who is a repeat customer, has historically spent large amounts on meals, is a good tipper or meets some other criteria may have fees waived for reservations or may be offered discounts or other benefits. As shown at step 2718, the data collected may also be used for dynamic capacity planning and management as described above. For example, a customer who has a longer turnover time historically may be allocated a longer estimated turnover time for a reservation in determining when to schedule the next open reservation.

As shown at step 2720, selected items of data may be made available for searching and viewing by restaurants. The restaurant management interface may allow search criteria (such as string matching with wildcard characters, boolean expressions or the like) to be used to search and match data records for customers, reservations, demand data or other data in the system for display. In some examples, search criteria can be defined for any data fields to search for matching records. In some examples, restaurants may access all restaurant specific data (or for restaurant groups managed through common or linked accounts) as well as averages and benchmarks across other restaurants. In example embodiments, tags (including custom tags created by the restaurant) may also be used to search and filter data.

As shown at 2716, search and filter criteria may also be used to identify records (for example, for customers) who meet criteria for targeted communications, alerts, promotions and advertising. For example, a restaurant may be permitted a certain quantity of messages, emails or alerts to a consumer (or posted on a message board on the web interface of the user's account) for promotions, discount offers or the like. The data collected at 2712 may be used to establish criteria to identify guests who should receive the promotions or discounts as well as the promotions or level of discounts to be offered to particular guests. For example, repeat customers or guests who spend above a threshold amount per person on reservations may be selected to receive promotions. In addition, other benefits, such as waivers of reservation fees and priority for booking open reservations, may be offered or provided based on criteria or rules established by the restaurant through the restaurant management interface or by the service provider who operates web server 202. In addition, demographic data, historical data, reservation data (including location of a restaurant for an upcoming reservation on a particular date) and other data regarding particular consumers on system 202 may be used to target advertisements and promotions from other advertisers, including banner ads from ad servers or other ad placements. For example, a user who has a reservation in a particular city on a particular night might receive ads or promotions related to local events occurring later that night near the same location. If the location is away from the user's home address, an ad or promotion for a hotel near that location may be provided. These are examples only and other targeted advertising or promotions may be displayed or offered based on any of the data collected by the system.

As shown at 2722, the consumers who use the service may also be provided access to selected data for searching, filtering and/or sharing. For example, a customer may review all past and upcoming reservation data for that customer's reservations, including the reviews and feedback provided by the customer. The system 100 may provide interfaces that allow recommendations, ratings or reviews to be shared with other users or entities that are associated through one or more social network services. For example, system 100 may include an interface to allow a user to post or share reviews, recommendations or other data with friends or other associated entities on a social network service. The social network services may be part of system 100 (for example, system 100 may all the user to define groups of users who are “friends” or otherwise have access to selected data from the user's account, including restaurant recommendations) or provided through other services such as Facebook or Google+. In some example embodiments, system 100 may automatically recommend restaurants to users based on restaurants that received positive feedback from other users who are identified as “friends” or otherwise associated with the user through the system 100 or through another social network service. In an example embodiment, the guest database or user account database may include social profile information, including lists of users and entities who are associated as “friends” or are otherwise associated with a particular user.

FIG. 2N is a flow chart illustrating an example method for making reservations on a mobile client device being used by a consumer to access system 100. For example, the client device may be a mobile phone or tablet computing device and communicate with web server 202 through a wireless network in example embodiments. As shown at 2802, the customer may set preferences and configuration information for the user account and reservations. For example, the customer may establish a list of restaurants (for example, favorite restaurants) to use for searching reservations. The user may also tag the list based on the meal, day, time or the like (such as favorite restaurants for lunch or favorite restaurants or bars for a weekend night). Other filters and preferences may also be established. These parameters may be entered through a web browser interface on a computer or on the mobile device in an example embodiment and are stored in databases 108. System 100 may provide an interface to the user on the mobile device (for example, through a web browser interface or local application) to allow the user to request available reservations near the user's current location and within a period of time (specific in advance as part of the preferences or at the time the request is made). In some examples, a single user interface element is selected to search quickly for open reservations using pre-determined preferences. Location information from the mobile device (for example, from GPS data or other location information) may be used together with the user's preferences to search open reservations database 210 for available reservations near the user's location, at restaurants that meet the user's preference for the time or meal or type of food or other criteria (for example, favorite dinner restaurants on the weekend) and available within a specified time window (for example, in the next six hours). In example embodiments, a list of available reservations meeting the criteria is displayed as indicated at 2806. The user can then book the reservation. In some example embodiments, defaults are included for the size of party (for example, based on capacities available for open tables at the restaurant) and other reservation information so the user can quickly book the reservation (for example, with a single click or single selection of a user interface element) as indicated at 2810. In addition, the user interface may provide the user with the option to edit the reservation request before booking the reservation (for example, to change the size of the party) as indicated at 2812.

FIG. 20 is a flow chart illustrating a method for a user to access real-time information regarding the reservation during the course of the meal and electronically authorizing and paying the bill at the end of the meal through the user's account or a local application on a mobile client device that interfaces with system 100. In example embodiments, the consumer may make a reservation through system 100 using any of the methods described herein, including paying for premium reservations, pre-paying for a meal such as a fixed price menu meal, receiving a discount for a reservation, obtaining a reservation by paying to transfer a reservation already made by another guest, using a quick placement reservation button on a local device of the consumer, or having the reservation entered by restaurant staff through the restaurant management interface, walk-in or other method for creating a reservation for the guest. As shown in FIG. 2, reservations may be made by the consumer through his or her user account as indicated at 2902 and/or by a restaurant through the restaurant account and restaurant management interface. As indicated at step 206 (and as described further below), when the guest arrives at the restaurant and throughout the course of the meal, the status and other data regarding the reservation may be updated dynamically (automatically or manually by restaurant staff through the restaurant management interface), including the table assigned, size of the party, time slot for the reservation, number of guests, status (arrived, waiting, seated, on appetizers, on entree, on dessert, bill ready, bill paid, completed or other status) or other information. In some embodiments, as indicated at 2908, the wait staff then enters order information (for example, food items, beverages and other items ordered by the customer) through the restaurant management interface on a local client device at the restaurant such as an application on a tablet computing device 250. The wait staff may also display and modify order items, display notices, requests or alerts from the user (entered real-time by the consumer on a mobile device and sent through the consumer's user account while in the restaurant during the meal) or from the system and generate and/or print or electronically send bills or receipts. In example embodiments, this data may be stored in reservations databases 208 and 258 for the particular guest's reservation and/or in the guest databases 212 and 262. In example embodiments, the restaurant staff may also enter preferences, notes and other information regarding the reservation or guest during the course of the meal that may be automatically stored in these or other databases. The data may include data that can be accessed and reviewed by the consumer through the consumer's user account (such as items ordered and amounts charged) as well as data that can be accessed and used by restaurant staff and not by the consumer (such as preferences, complaints or other data for use by the restaurant). In example embodiments, the data may be associated with records in the reservations databases 208 and 258 and/or in the guest databases 212 and 262 that are available only through the restaurant's or restaurant group's particular account and not made available to other restaurants (such as wine or menu item preferences noted by the wait staff at a particular restaurant). Other data, such as number of cancelled or missed reservations, may be used by the system 100 to determine preferences or settings for the guest across different restaurants (such as whether to award special status, provide discounts, credits or benefits, charge for reservations, permit the consumer to receive requests for bumping or other settings).

As indicated at 2910, the consumer/guest may also access information from system 100 through the user account and/or local client application during the course of the meal. The user may review items ordered and order status, review charges and other billing information, place orders for additional items (electronically without waiting for the waiter to come to the table physically) or send alerts or other requests (electronically without waiting for the waiter to come to the table physically). For example, the user may send a request for the waiter to come to the table or refill water or some other request. These notices, alerts, requests and orders may then be provided by system 100 to the restaurant management interface for display to the wait staff on a client device used by the wait staff. As indicated at 2912, the consumer may also choose to enter a tip amount and authorize payment of the bill. As indicated at 2915, system 100 then arranges for the payment amount to be charged to the user using payment information previously provided by the user in the user account (for example, during registration, when the reservation was made or for prior payments) or the user may enter alternative payment information. System 100 may implement payment processing directly or interface with another service for payment processing to be performed. Upon receiving confirmation that payment has been made, system 100 may send an alert or notice to the restaurant staff via the restaurant management interface that the guest has paid the bill. The system 100 may also send a confirmation or electronic receipt to the consumer via the user account or mobile client device being used by the consumer to interface with system 100 as indicated at 2916. In example embodiments, the above may permit guests to make requests to wait staff and pay bills without waiting for the waiter to physically come to the table. In addition, the order, price and payment information and other data regarding fulfillment of the reservation may be stored for future use as described above.

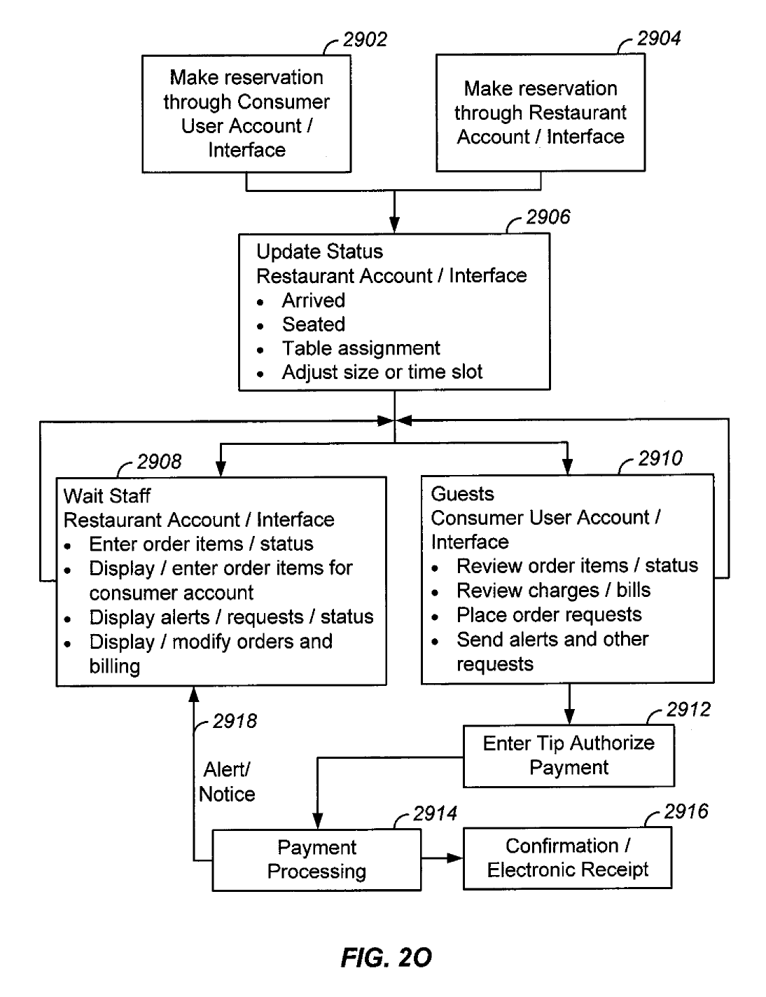

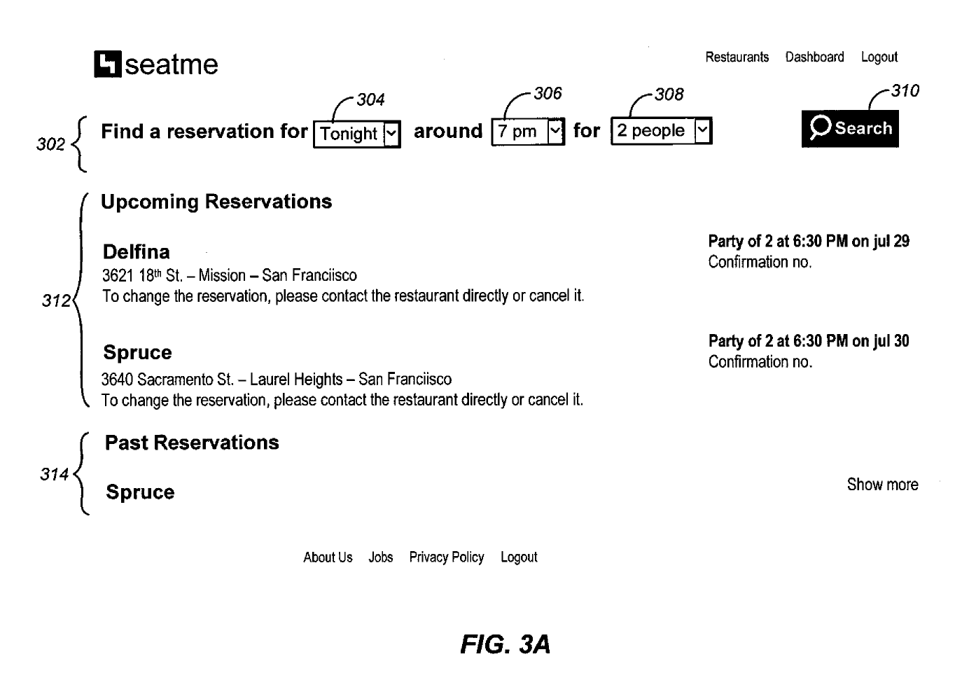

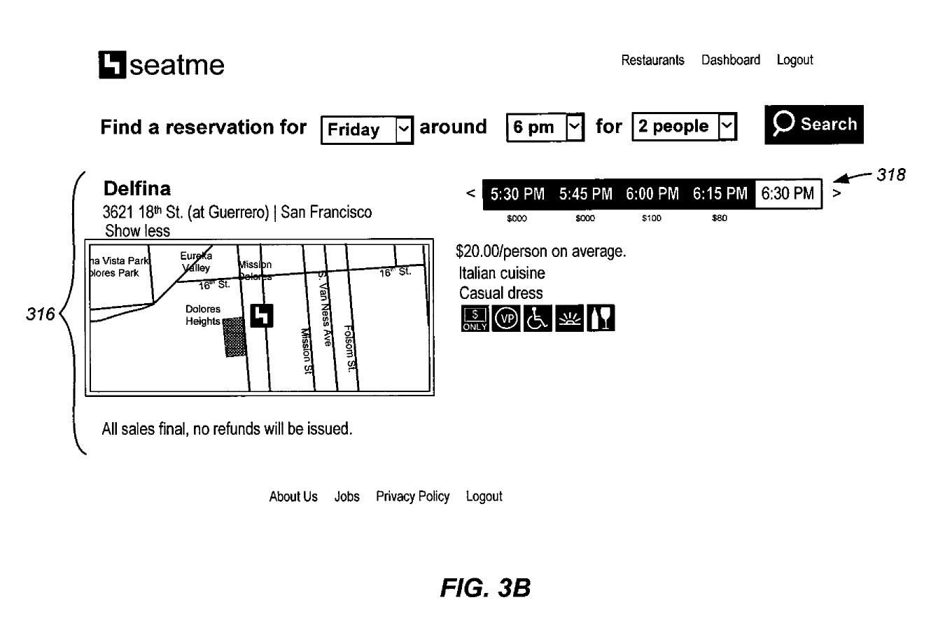

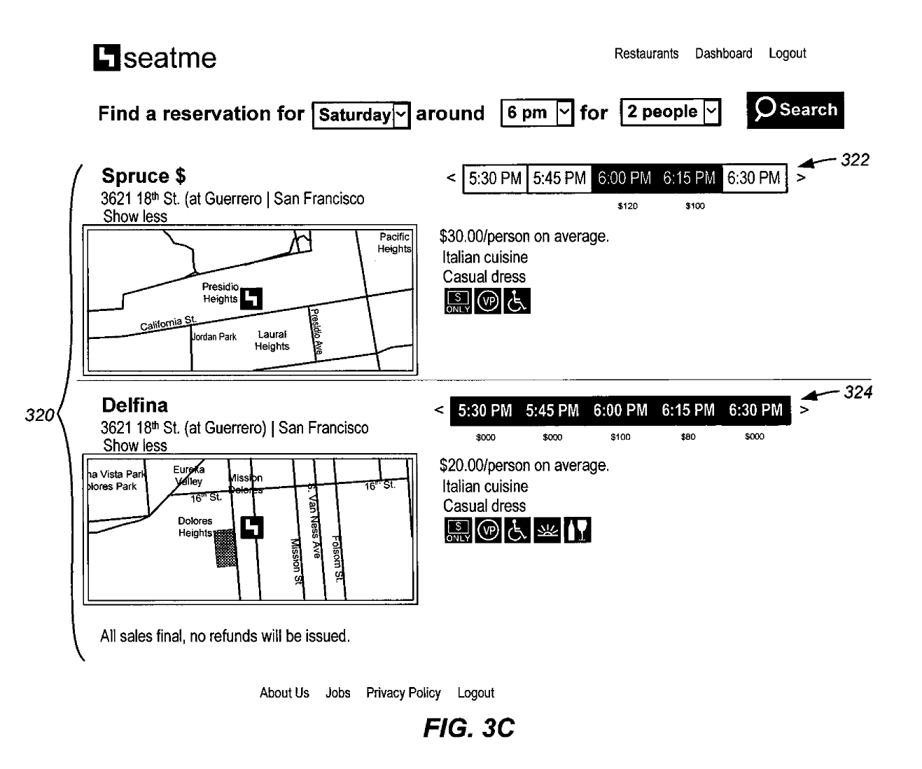

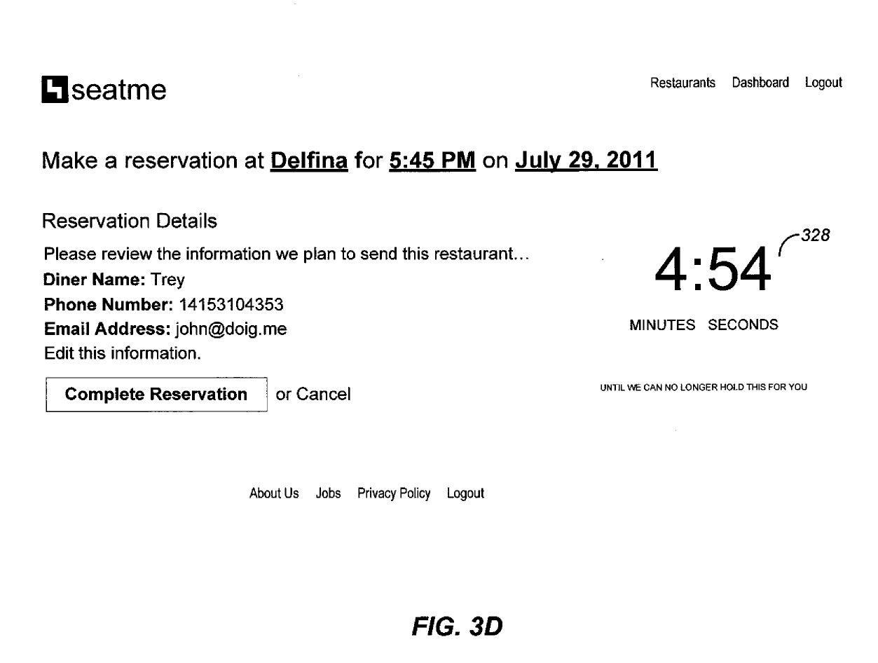

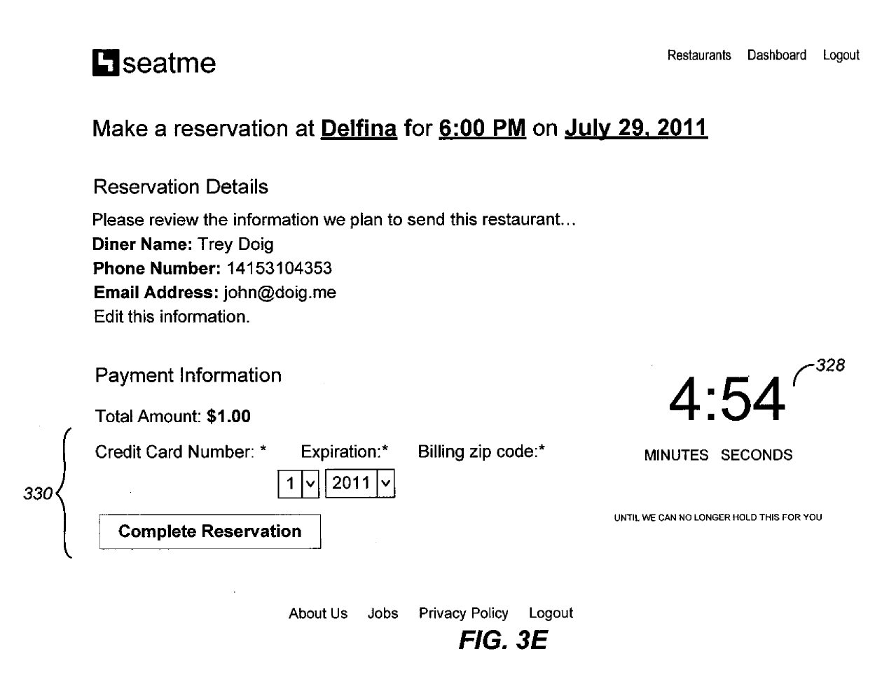

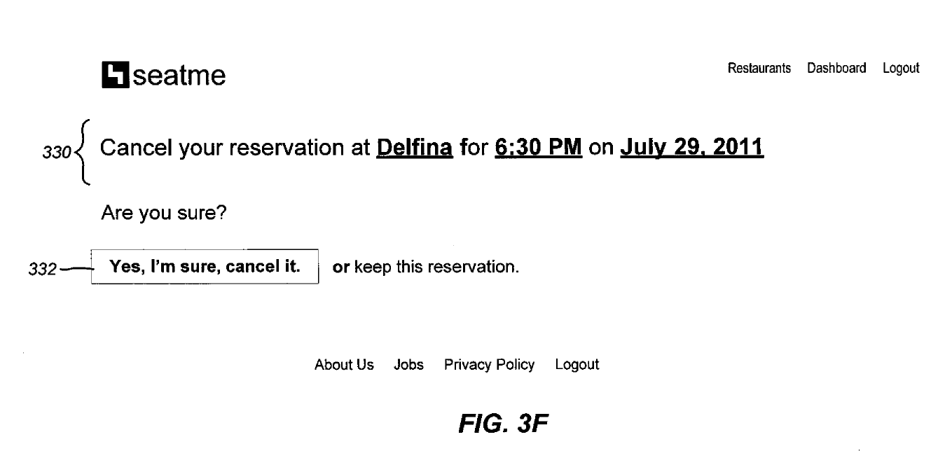

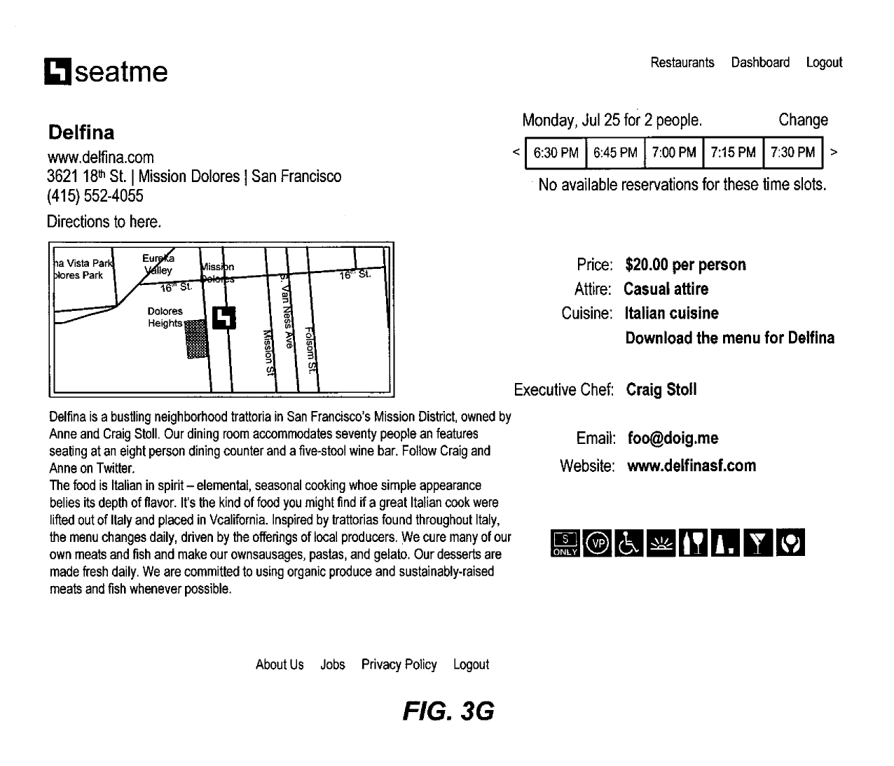

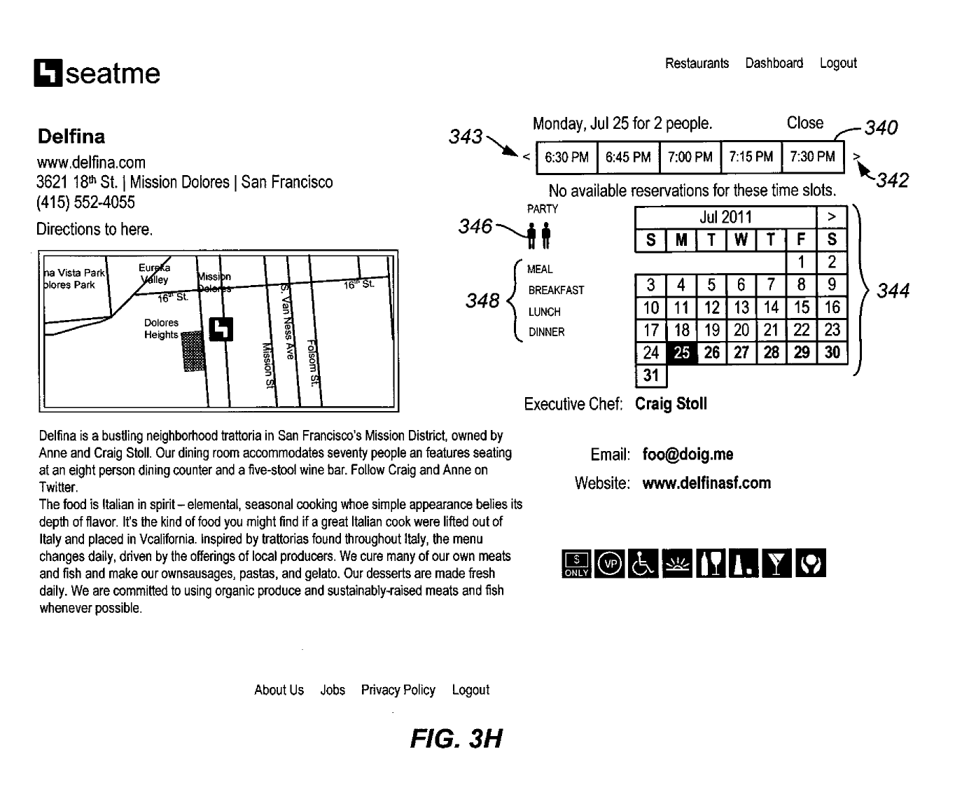

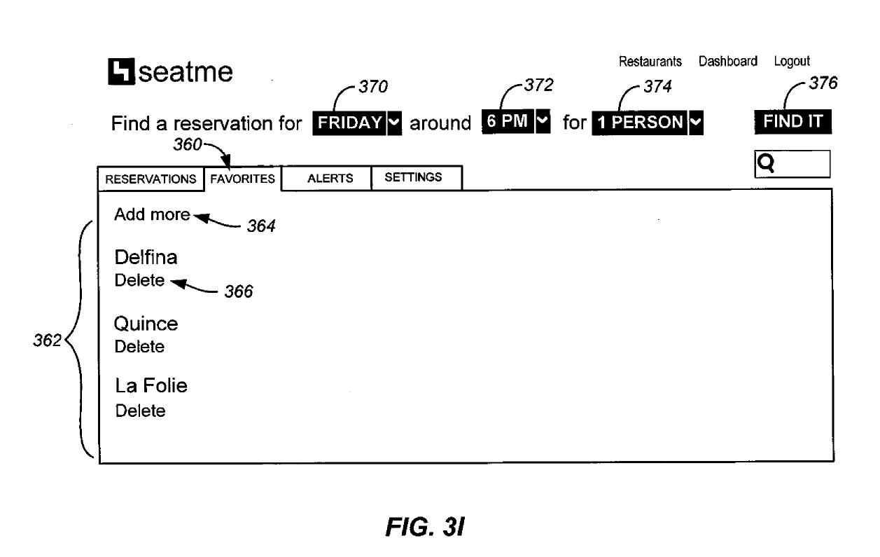

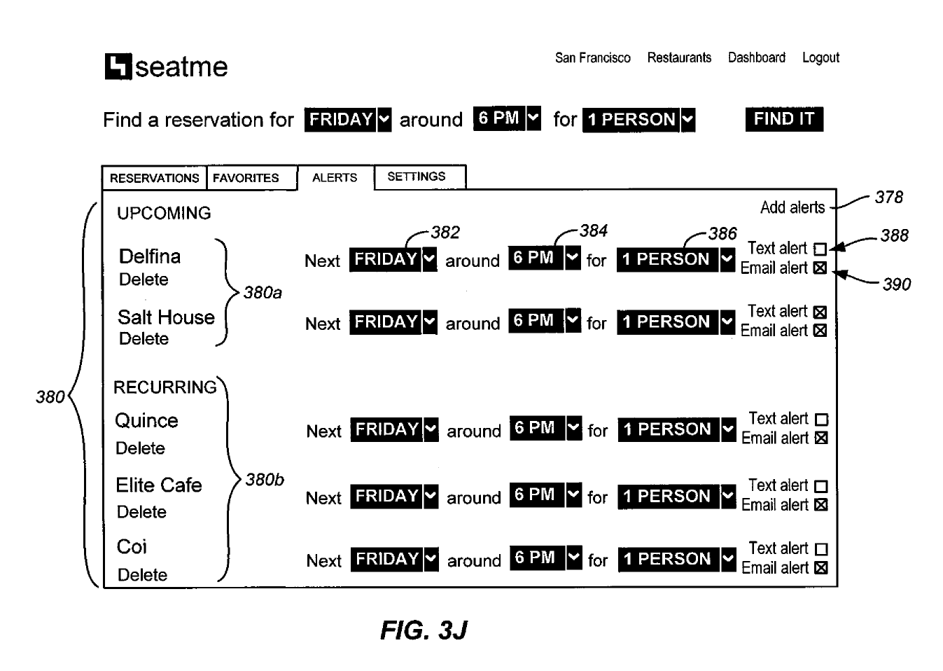

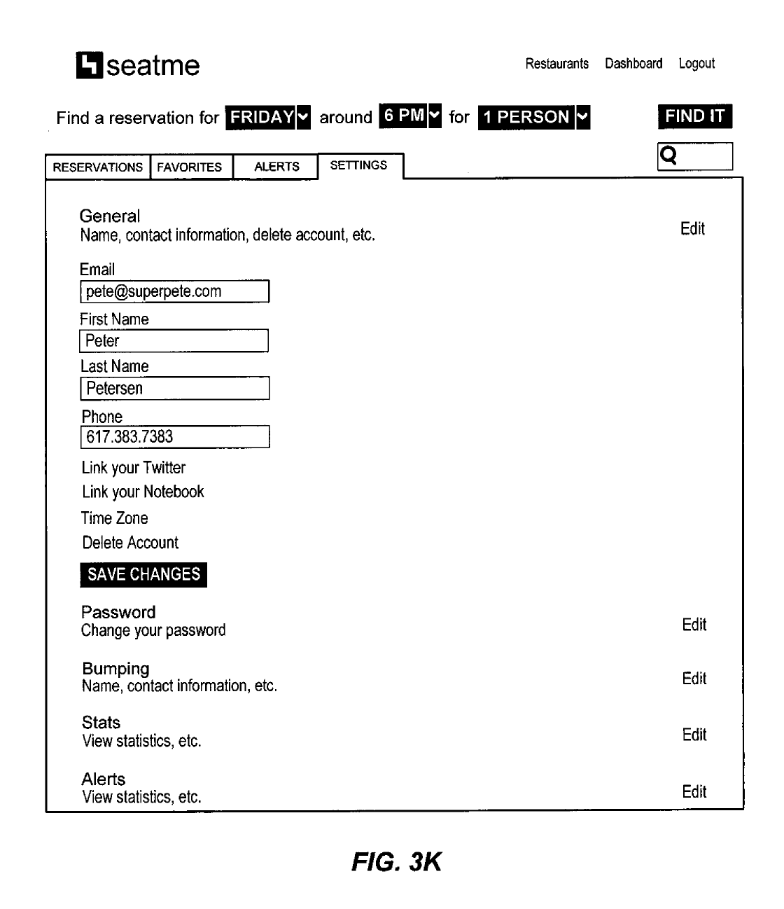

FIGS. 3A-3K show example screens of a user interface that allows a consumer 204 to interact with the web server 202, including to search for and make reservations at restaurants participating in the service. FIG. 3A shows a screen of the user interface that is displayed by a web browser when a consumer 204 logs into the online service. As shown in FIG. 3, a search interface 302 is provided where a user can search for available reservations. In an example embodiment, a search interface may be displayed on a web page along with other information about the users account and reservations. In this example, the user may specify the day 304, time 306 and number of people 308 for the desired reservation. In some embodiments, the user may also enter additional search criteria such as a geographic location, type of cuisine, restaurant rating or any other parameters for information available to the system about participating restaurants or open reservations. The user may then search for available reservations by selecting the search button 310. The specified criteria may then be used to search for available reservations in the open reservations database 210.

In an example embodiment, information about open reservations is stored in the open reservations database 210 and may be queried based on the parameters specified by the user. In an example embodiment, each record of the open reservation database may include fields that specify data about the available reservation as described above.

FIG. 3A also includes a list of upcoming reservations 312 that the user has already booked as well as a list of past reservations for the user 314. The list of reservations for the user is available from the guest database 212 and reservations database 208 as described above. Each reservation may be selected (for example by using a mouse click or selecting by tapping a touch screen on a tablet computer) to link to a page with additional information about the reservation. Each reservation may be stored as a record in the reservations database 208 and may include fields that specify data about the reservation as described above.

FIG. 3B shows a search results page of the user interface according to an example embodiment. The search results in FIG. 3B shows a single search result 316 for available reservations at Delfina restaurant. The search result shows the restaurant name and address, a map showing the location of the restaurant, average price, type of cuisine, attire and other information regarding the restaurant. This information may be retrieved from the restaurant profile database 214 for the restaurant that is linked to the available reservations in the open reservations database 210.

An interface element 318 is also displayed which shows time slots for reservations around the specified time. In the example shown in FIG. 3B, the user specified a reservation time of 6 pm for the search. The interface element 318 displays time slots for reservations from one half hour prior to the specified time until one half hour after the specified time. In other embodiments, other ranges around the specified time may be displayed. Each time slot that has available reservations for the specified number of people is highlighted to show that it is available. Other embodiments may use other indicia to indicate that a reservation is available. In the example shown in FIG. 3B, reservations at 5:30, 5:45, 6, 6:15 and 6:30 are highlighted as available. The 6:30 time slot is faded to indicate that it is not available. Underneath each available time slot is a price indicating the fee required to be paid for the reservation. In this example, the 5:30 and 5:45 time slots do not require any reservation fee. The 6:00 reservation requires a $100 reservation fee and the 6:45 reservation requires an $80 reservation fee. In example embodiments, the prices for reservations may be determined dynamically by the software application 106 using information from the pricing engine database 206, which may include pricing parameters and rules established by the restaurant and service provider as described above. In some embodiments, arrows or a monthly calendar may be displayed to allow the user to scroll through other times or dates to view open reservations at the specified restaurant.

FIG. 3C shows a search results page of the user interface according to an example embodiment where multiple search results 320 are displayed. In this example, search results for the restaurants Spruce and Delfina are displayed. The user interface displays an interface element 322 and 324 for each restaurant showing available time slots for reservations around the specified time. Interface element 322 shows available time slots at 6:00 and 6:15 for Spruce, with a reservation fee of $100. Interface element 324 shows available time slots at 5, 5:30, 6, 6:15 and 6:30 for Delfina, with a reservation fee of $100 at 6 and $80 at 6:15. The other time slots do not require a reservation fee.

If the user selects a time slot (for example, by clicking on the time slot in interface element 316) then a web page will be displayed for completing the reservation. FIG. 3D shows a page of the user interface that is displayed for completing a reservation that does not require payment of a reservation fee. A timer 328 is shown which displays an amount of time remaining to complete the reservation. If the time expires before the reservation is completed, the selected reservation is released and returned to the available inventory in the open reservations database 210. FIG. 3E shows a page of the user interface that is displayed for completing a reservation that requires payment of a reservation fee. This page includes an interface element for entering credit card information 330. When the reservation is completed (by selecting the “Complete Reservation” button), the credit card is charged the reservation fee by the service provider. In this example, the reservation fee is $1. As described above, this fee may then be allocated between the service provider and the restaurant based on allocation rules in the pricing engine database 206.

FIG. 3F shows a page of the user interface that is displayed for canceling a reservation. The user can select a reservation from the list of upcoming reservations (as shown at 312 in FIG. 3A) to be canceled. In FIG. 3F, the reservation to be canceled is identified by restaurant, time and date as shown at 330. The reservation can be canceled by selecting the button at 332. When a reservation is canceled, it is removed from the reservations database 208 (or may be flagged in the reservation database as a canceled reservation that can be viewed by the user) and is marked as an available reservation in the open reservations database 210. In some embodiments, the system may store information in the guest database 212 regarding the number of canceled reservations for the user and can use historical information about a user's cancellations as a factor in determining whether to charge a reservation fee in the future. If a reservation fee has been charged for the reservation, the reservation fee may be retained by the service provider in some embodiments. In some embodiments, the reservation fee may be retained if reservations remain unfilled for the selected time or if the user has passed a threshold number of cancellations that could not be filled. In some embodiments, the reservation fee may be retained if the time until the reservation is less than a specified amount. In some embodiments, the user may receive a credit in the amount of the reservation fee to use at the selected restaurant in the future or for purchasing a premium reservation for the selected restaurant or another restaurant in the same restaurant group or, in some embodiments, at other restaurants available on the service. The parameters and rules for specifying when a refund or credit or other accommodation is made for a canceled reservation may be specified in the pricing engine database 206 in an example embodiment as described above.

FIG. 3G shows a restaurant profile page according to an example embodiment. The restaurant profile page displays information about a restaurant from the restaurant profile database 214. In an example embodiment, this information may include restaurant name, address, location, a description, a photo gallery (not shown in FIG. 3G), time slots for available reservations, typical price, attire, cuisine, executive chef, email, website, twitter account and other information about the restaurant. The time slots for available reservations may be an interactive or selectable interface element, and may be the same or similar to the interface element used on the search results page for making reservations. Arrows or a monthly calendar may be included in some embodiments to allow a user to scroll through other times or days to look for available reservations. If a time slot is selected, a screen may then be displayed to allow the user to complete the reservation.

FIG. 3H shows a software applet or widget that can be used to interact with the management and reservation system from a web page from another publisher, such as server 150 in FIG. 1. A tag may be included on the page to download a script that causes the user interface to be displayed. The user interface displays similar information to the restaurant profile page described in FIG. 3G as well as an interface element 340 for finding available reservations. Interface element 340 includes a monthly calendar for selecting the day, an interface element 346 for selecting the number of people, and an interface element 348 for selecting the meal for the reservation. Time slots are displayed at the top of interface element 340 with available time slots highlighted. In some embodiments, a price for premium reservations may be displayed below available time slots as shown in FIGS. 3B and 3C. Arrows 342 and 343 can be used to scroll through other time slots for reservations for the restaurant. At any time, the user can select an available time slot and a page will be displayed for completing the reservation, such as the example pages shown in FIGS. 3D and 3E. This interface element 340 can easily be made available on other publishers web sites by including an appropriate tag. In addition, the interface element 340 may be included on web pages provided by web server 202 as part of the management and reservation system 100 as an additional interface for searching and selecting available reservations.

FIG. 31 shows an example search page interface according to an example embodiment in which a user can search among a list of favorite restaurants. In an example embodiment, the user may select a user interface element, such as tab 360, to display a list of favorite restaurants 362 for searching. The user may select a user interface element, such as the “add more” link 364, to add additional restaurants to the list. The user may also select a user interface element, such as the “delete” link 366, to delete a restaurant from the list. In this example, the user may enter search criteria using a user interface element, such as search bar 368 with input fields for day 370, time 372 and number of persons 374 for the reservation. The user may then search for reservations meeting the criteria among the list of restaurants 362 by selecting search button 376. The results may then be displayed on a search results page such as the example search results pages shown in FIGS. 3B and 3C. In other example embodiments, the user may define multiple lists of restaurants for searching and save the lists under names or tags assigned to the lists in the guest database 212 as described above. The user interface may also provide an option for selecting some or all of the restaurants on the list for searching, for example by providing a selectable check box next to each restaurant on the list.

FIG. 3J shows an example page of a user interface for establishing alerts to be sent to a user when reservations meeting specified criteria are available. A user may add an alert by selecting a user interface element, such as the “Add alerts” link 378. The user then enters the name of the restaurant which is then added to a list of restaurants 380 that have alerts. The user may also specify whether the alert is a one-time alert for a specific upcoming day (as shown at 380a) or a recurring alert any time reservations meeting the criteria are available (as shown at 380b). In an example embodiment, the user may specify the parameters for the alert for a specified restaurant through a user interface elements, such as input fields to enter the day 382, time 384 and number of persons 386 for a reservation at a particular restaurant. The user may also specify the manner for sending the alert through a user interface element, such as check boxes 388 and 390 specifying that the alert should be sent as a text message or email message or in another manner to be specified by the user. The alerts configured by a user may be stored in the guest database 212 as described above. The system runs searches at the specified restaurants using the search criteria that have been entered. The search may be run periodically, such as whenever reservations are canceled at the specified restaurant or at specified intervals, such as once a day or once an hour. If a reservation matching the criteria becomes available an alert is automatically sent to the user with the date, time and number of people for the reservation that is available at the specified restaurant. When an available reservation meets the criteria for alerts for multiple users, the alerts are sent at the same time in an example embodiment. The alert may include a link that the user can select to book the available reservation (for example, through pages such as those shown in FIGS. 3D and 3E). The reservation is then booked by the first user to complete the reservation and a subsequent alert may be sent to other users indicating that the reservation is no longer available. In an alternate embodiment, priority may be provided to guests based on special status (see 2076 in FIG. 2D) that has been assigned to the user. For example, users may receive different priority and alerts may be sent first to users who meet certain criteria. For example, users who are regular customers at the restaurant (for example, based on number of visits over a period of time, such as the last year) or who have purchased a larger number or dollar value of premium reservations through the system or who have a fewer number of last minute cancellations of reservations could receive priority. The alert may specify an amount of time until additional alerts will be sent or the reservation will be made generally available to other users on the web site. In another example embodiment, the pricing engine 206 may include pricing rules that dynamically price reservations based, at least in part, on the number of alerts that have been set for criteria that match the reservation that has become available. If a large number of alerts are set for criteria matching a reservation, the reservation may be identified as a premium reservation for which a charge is required or the charge for the premium reservation may be increased based on the number of alerts. In addition, the pricing rules may take into account how many users have searched using criteria matching the reservation (or similar reservations at the same or similar restaurants) and/or how many searches matching a reservation (or similar reservation) have failed to identify available reservations.

In other example embodiments, a similar page may also be used to configure reminders to be sent by text message or email or in another manner to the user to remind the user of an upcoming reservation. For example, the user may set a date and time when the reminder should be sent, for example one day prior to the reservation. The system 100 then automatically generates a reminder message with the date, time and number of people for the reservation and sends it to the user using the specified mechanism, such as a text or email message.

FIG. 3K shows a page that may be used by a user to configure settings for the user's account on system 100. For example, data fields in the guest database 212 may be entered or updated, such as email address, name, phone number and password. Preferences for bumping or alerts may also be specified or updated.

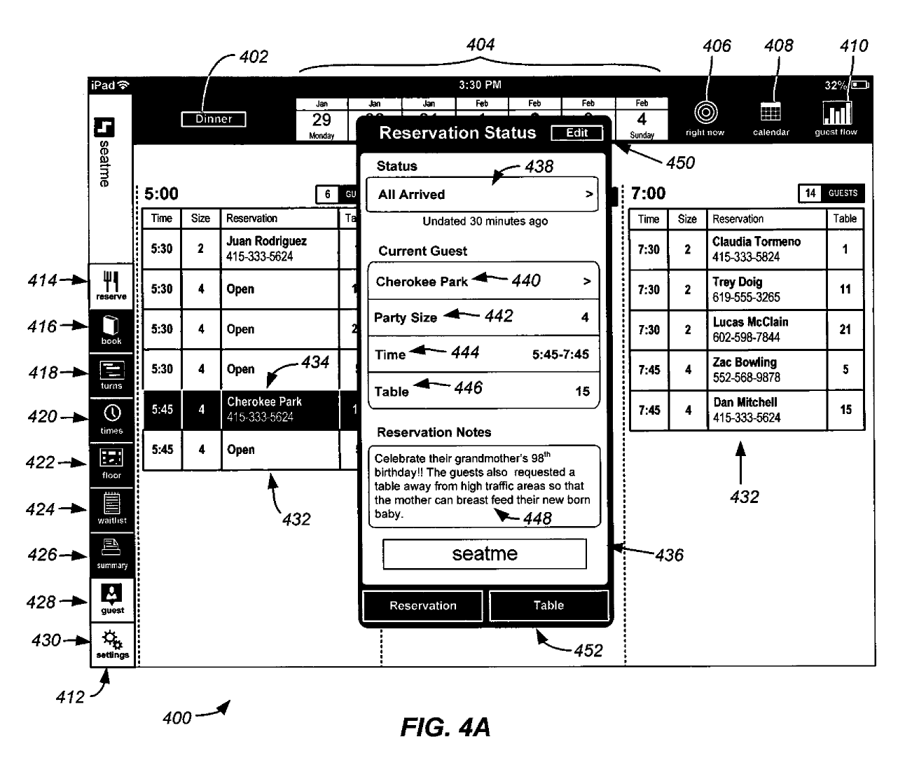

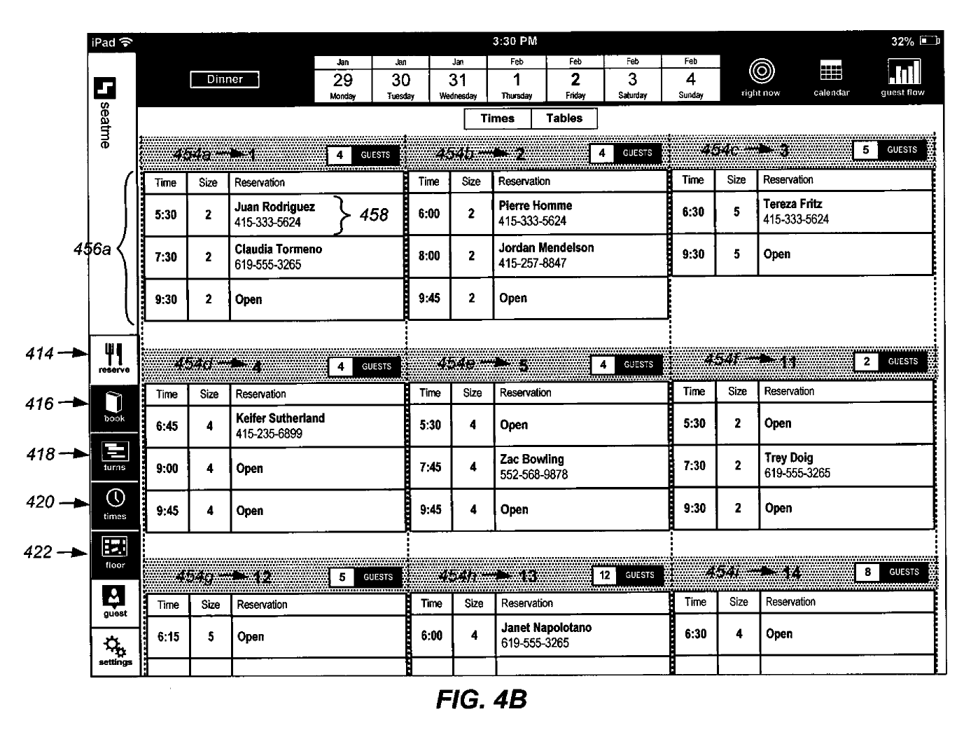

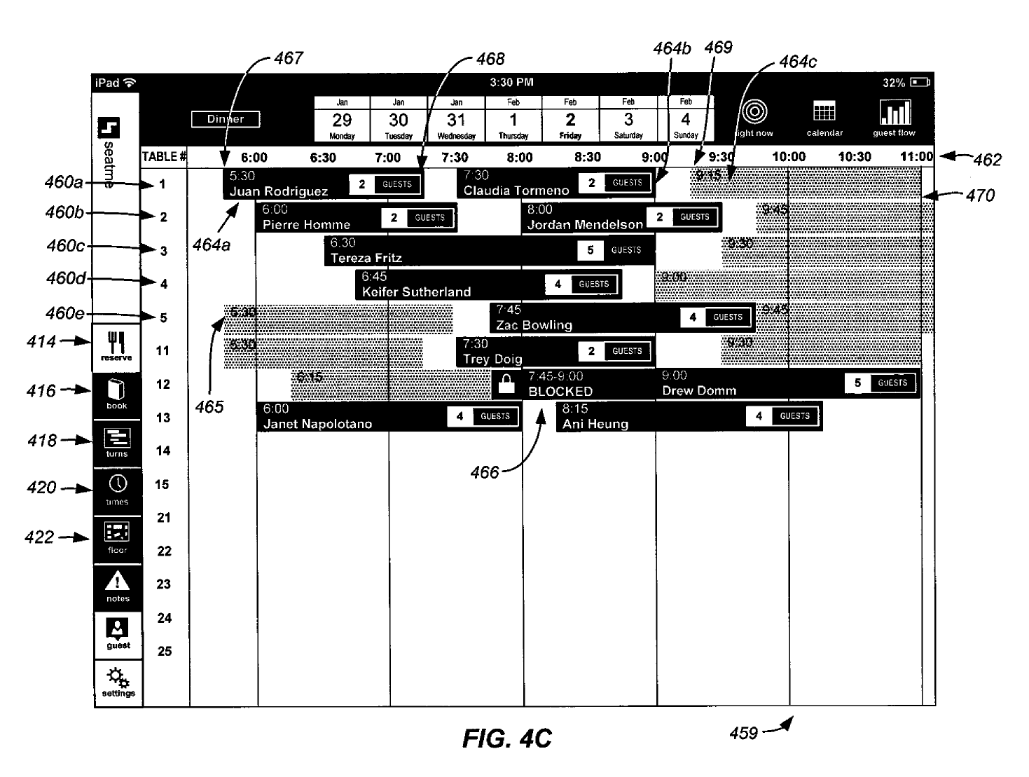

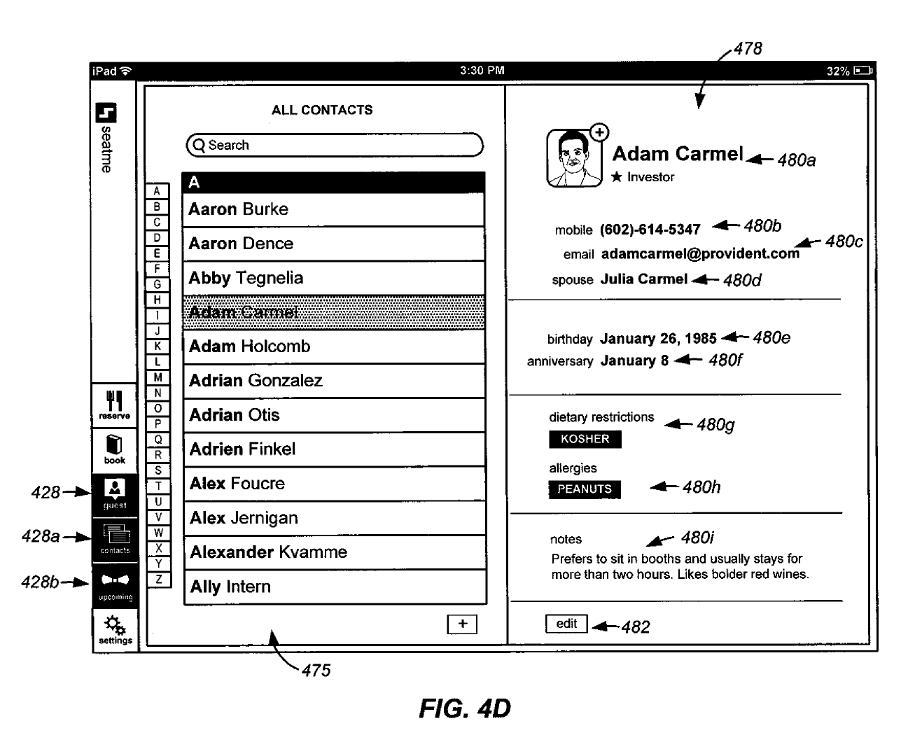

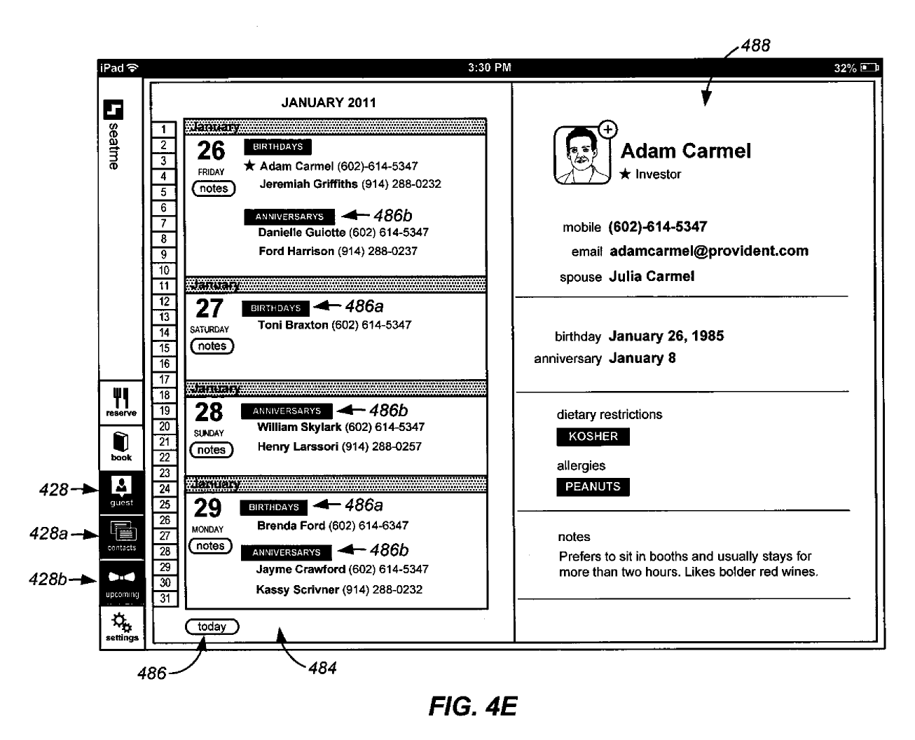

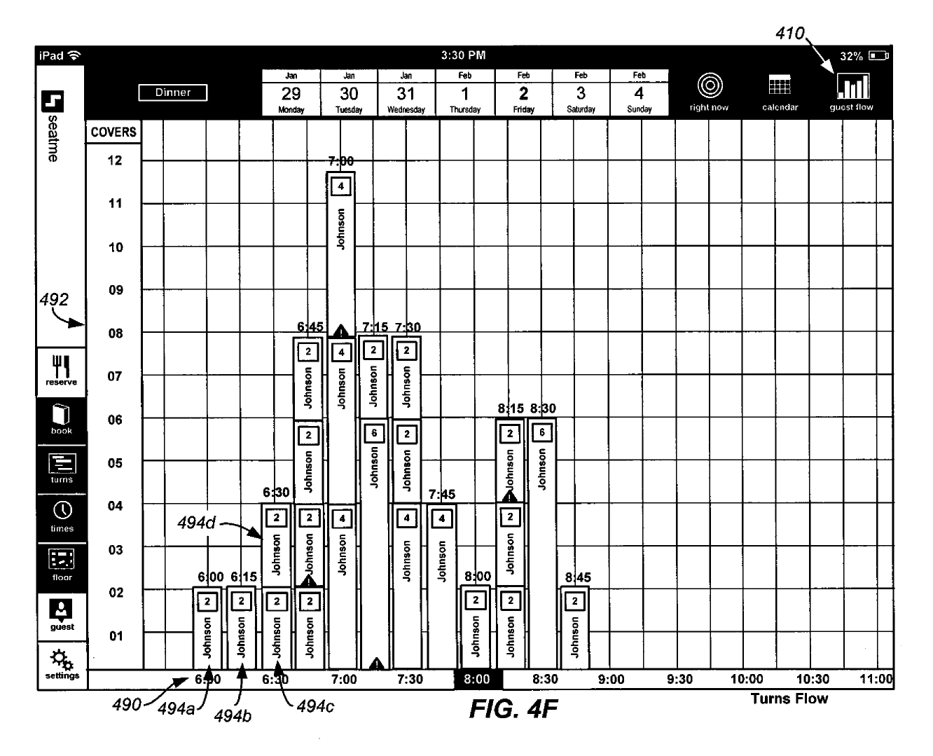

FIGS. 4A-4F show example screens of a user interface for application 250 that allows restaurant staff 252 to interact with the system 100. In an example embodiment, information regarding reservations, seating and other restaurant management functions may be stored locally in databases on local client devices 114, such as a tablet computing device. In an example embodiment, these databases may be synchronized with versions of the databases 108 stored on server 102.

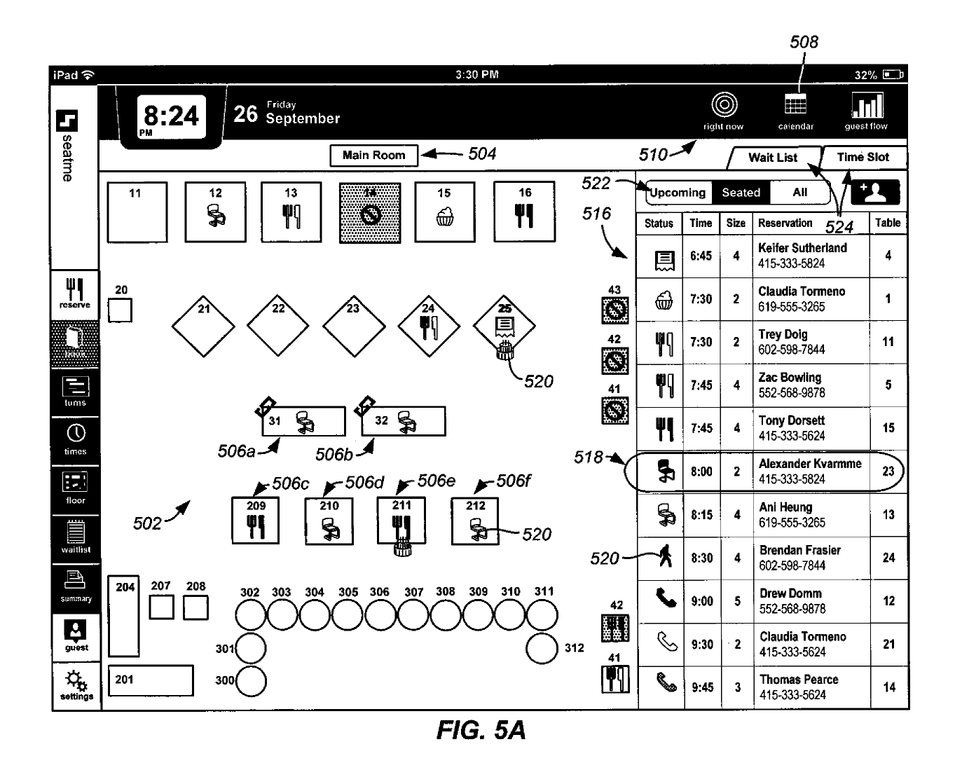

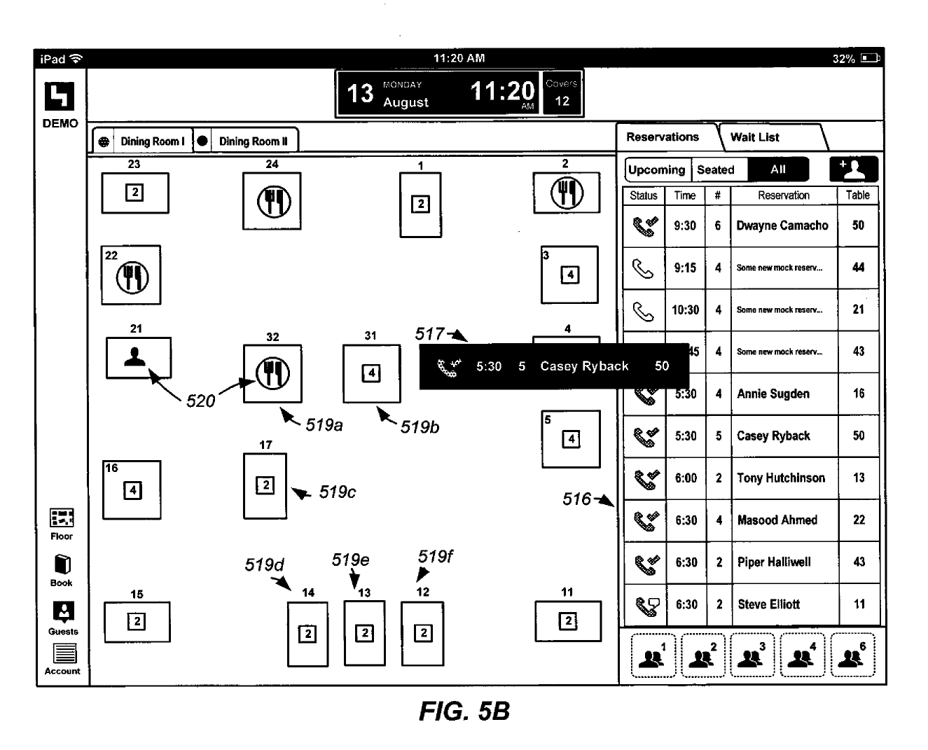

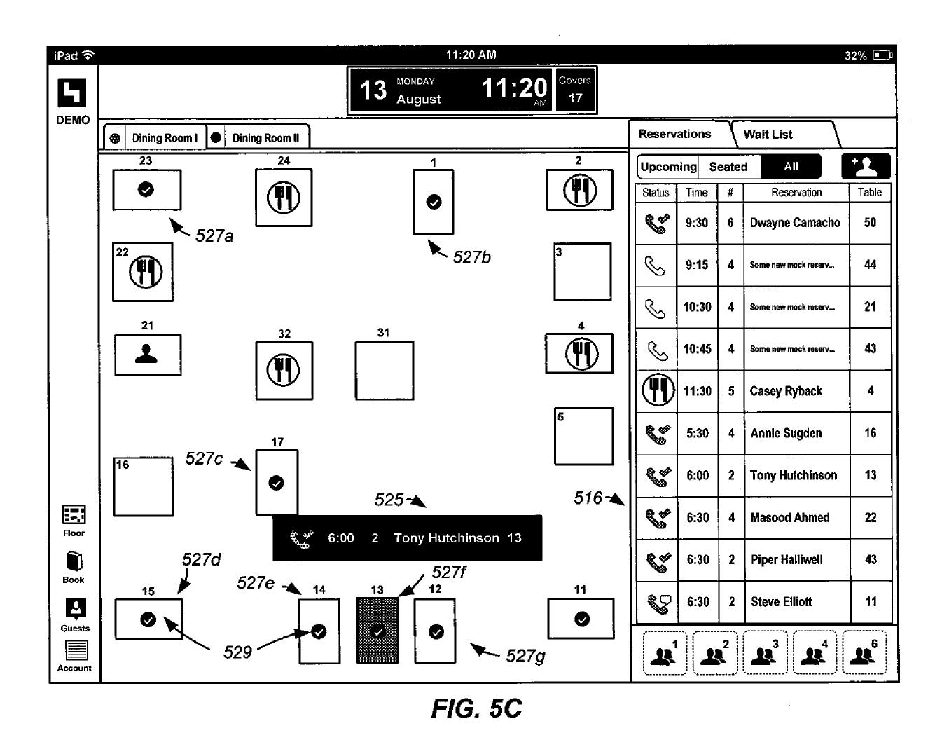

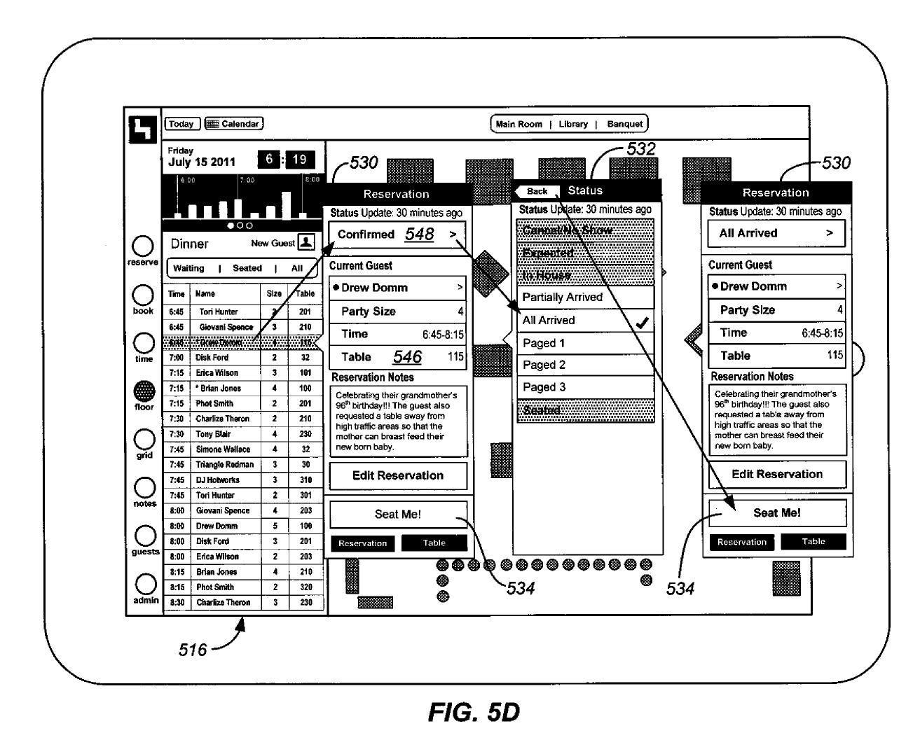

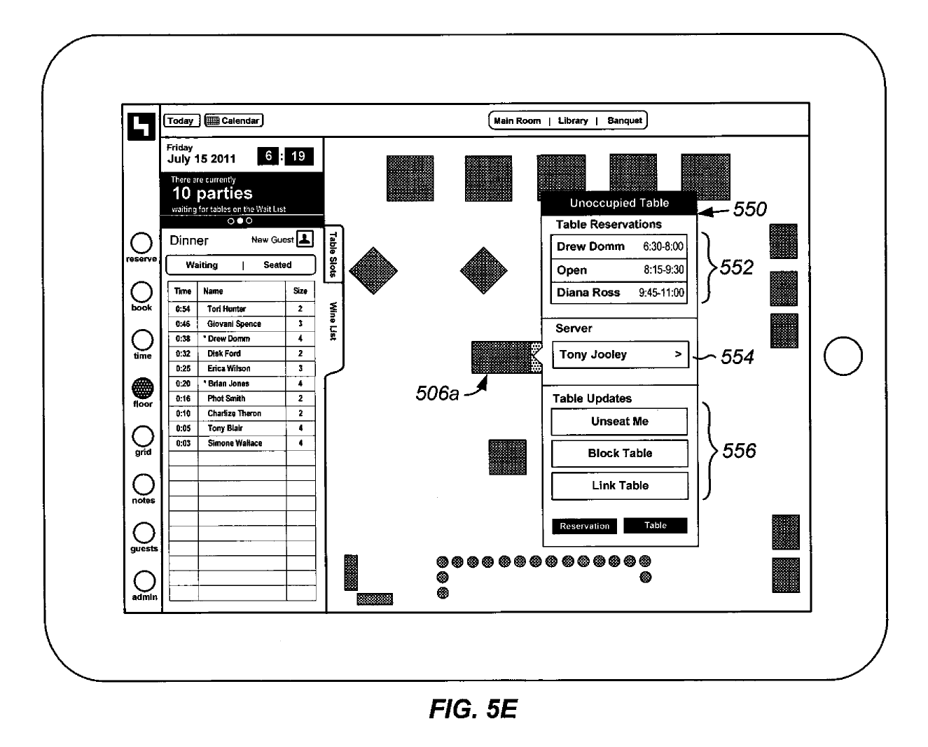

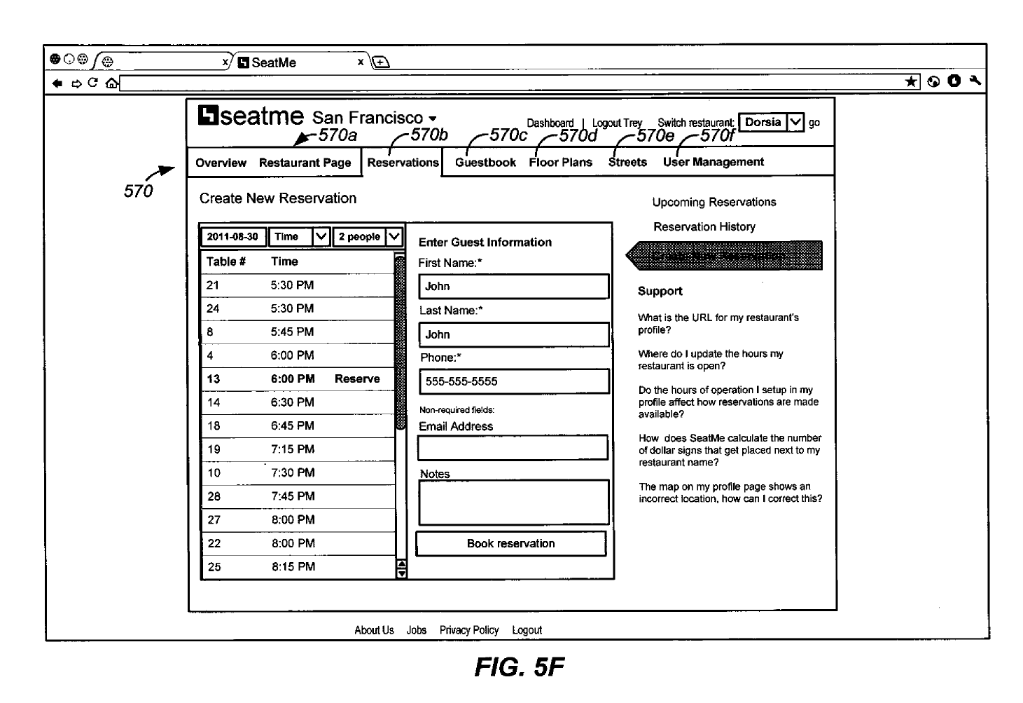

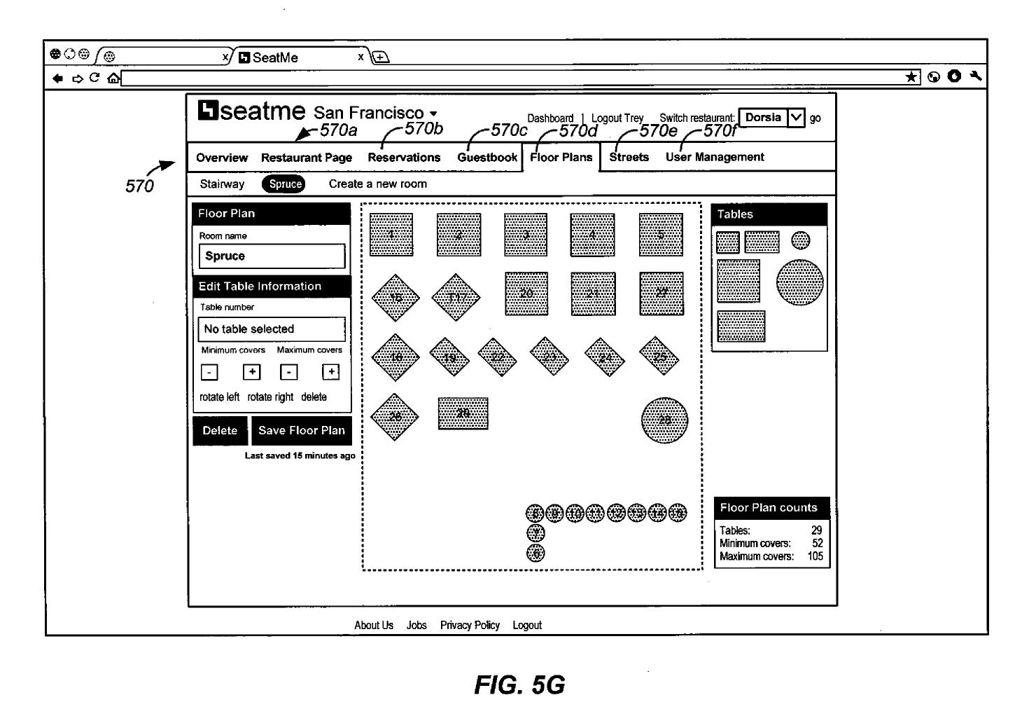

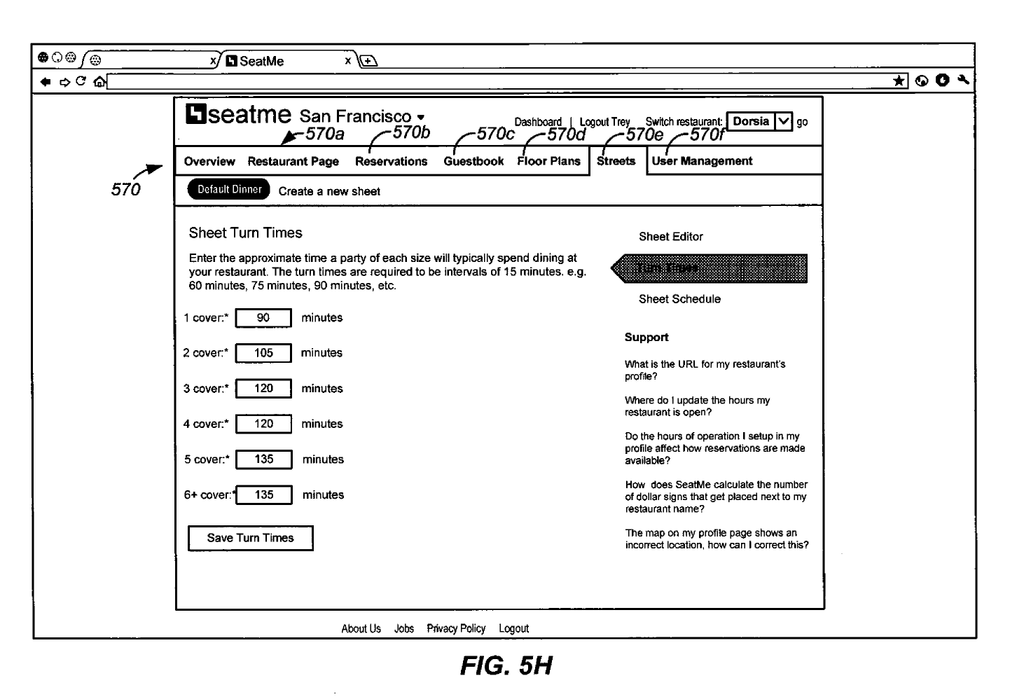

FIG. 4A shows an example page 400 of the user interface for application 250 listing reservations by time slot. At the top of the page are user interface elements for selecting a particular day or time or other criteria for viewing reservations, such as a button for selecting the shift (such as the dinner shift) 402 for which reservations are displayed, buttons for selecting the date 404 within the current week for which reservations are displayed, a “right now” button 406 to view reservations for the current time slot (or for some range of time before and after the current time, such as from one half hour before until one half hour after the current time) and a calendar button 408 for displaying a calendar to select a date to view. The user interface also includes buttons, such as the “guest flow” button 410 for toggling to a different view for displaying reservation information (such as the example “guest flow” page described in connection with FIG. 4F). A column 412 on the left side of FIG. 4A also includes user interface elements for navigating to other views of information managed by system 100. The “reserve” tab 414 has been selected and the column shows choices for different views and actions regarding reservations underneath the “reserve” tab 414, including “book” for booking reservations 416, “turns” for viewing information regarding reservations by table (see for example FIG. 4C) 418, “times” 420 for viewing reservations for particular times (which is selected, resulting in display of reservations by time as shown in FIG. 4A), floor 422 which shows a floor plan view for reviewing and managing reservations (see for example, FIGS. 5A to 5C), waitlist 424 which shows a list of guests who have arrived and are waiting to be seated, and summary 426 which provides summary information. Other categories that can be selected include a “guest” tab 428 which provides options for viewing a guest book with information on guests (see for example, FIGS. 4D and 4E) and settings 430 which can be used to configure settings for the restaurant's account on system 100 (including, for example, pricing and discount rules to establish criteria for dynamically providing pricing and/or discounts for certain reservations offered through system 100).

FIG. 4A shows a “times” view of the reservation information. The options on the display shown in the example of FIG. 4A have been selected to display dinner reservations for the current day from 5:30 until 7:45 pm. The reservations are shown in a list 432 ordered by the time. In this example, each reservation can be selected by tapping or otherwise selecting the user interface element for the reservation on the touch screen display. In the example shown in FIG. 4A, the user interface element for the reservation for Cherokee Park at 5:45 pm has been selected and is highlighted (see 434). In response to the user selecting the user interface element for this reservation, a pop up or overlay window 436 is automatically displayed showing information for this reservation. This information is retrieved from the reservations database 258 on the client device 258 or can be retrieved from the reservations database 258 on the server. In this example, the window 436 displays the status of the reservation in field 438 (for example, whether the party has arrived, has been seated or other information about the status of the reservation), the name under which the reservation was made in field 440, the party size in field 442, the time slot for the reservation in field 444, the table assigned to the reservation in field 446 and reservation notes regarding the reservation or guest in field 448. Each of these data fields may display the current information or may be selected (for example, by tapping the touch screen or using a pointing device) in order to change the data for the respective field in the reservations database. An “edit” button 450 may also be selected to open a window for editing and saving each of the fields. For example, the table may be changed by the restaurant staff if the assigned table is running late and another table becomes available. A user interface element, such as table button 452, may also be selected for viewing additional information regarding the table that has been assigned to the reservation (for example, the information displayed in the table view described in connection with FIG. 4B). Any changes to the reservation information are stored in the local reservations database 258 as well as in the reservations database 208 on server 102. Each of the data fields displayed for the reservation may be stored into a corresponding field in the reservations database 208 for the record representing the current reservation as described above. The changes are made available to other client devices accessing the restaurant's account by synchronizing the local reservations database with the server or by accessing the information directly from the server (for example, through a web browser interface).

In example embodiments, changes to a reservation may also be made by dragging a user interface element for a reservation 434 to another time slot on the screen 400. In an example embodiment, a user may drag or move a user interface element by using a finger gesture on a touch screen or by using a selection device, such as a mouse to select (for example, by clicking) and dragging the user interface element to another location. In an example embodiment, dragging a user interface element for a reservation (such as user interface element 434) automatically modifies to the time slot record for the reservation in the reservations databases 208 and 258 to reflect the new time slot and the user interface element for the reservation 434 is then displayed in the new time slot.

FIG. 4B shows a “table” view of the reservation information. This view is selected when the table button 452 from window 436 is selected (see FIG. 4A). The example user interface in FIG. 4B shows reservations organized by table. A user interface element is displayed for each table (454a-i for tables 1-14 in the example of FIG. 4B). For example, user interface element 454a displays the reservations for Table 1 in FIG. 4B. The table number is displayed at the top of the user interface element 454a. The reservations are then displayed in a list 456a in a portion of user interface element 454a. In this example, the reservations are listed by time. The user interface element for each reservation 458 in the list 456a shows the starting time, size, name and phone number for the reservation. In example embodiments, the user interface element for each reservation 458 may be selected in the same manner as the user interface element for reservations shown in FIG. 4A (see 434). When a reservation is selected, a window may be displayed to show and edit the data records for the reservation in the same manner as described in connection with window 436 in FIG. 4A. If the data field for the table 446 assigned to the reservation is changed, the user interface of FIG. 4B will automatically change the display to show the reservation in the new table. For example, if reservation 458 is changed to table 5 in the example shown in FIG. 4B, the 5:30 time slot for table 1 (see 454a) will be changed to “Open” and a record for an open reservation in the open reservations databases 260 and 210 will be available for this table. In an example embodiment, the record in the open reservations databases 210 and 260 that represented the available reservation for Table 5 is changed to Table 1 instead. The reservation for the 5:30 time slot in table 5 (see 454e) will automatically be updated to display the reservation for “Juan Rodriguez” (see 458). The record for this reservation in the reservations databases 208 and 258 will be updated to reflect the new table number 5 instead of table 1. In this manner, the seatings for tables can easily be changed by restaurant staff or by the service provider dynamically (or automatically by software based on rules established by the restaurant or service provider) to manage the seatings and reservations based on the times that guests arrive, the turnover time at each table, the load on particular wait staff or other factors. These changes are automatically reflected back into the affected databases 108 on the server 102 (for example, the floor plan databases 205 and 240 linking each table to a list of reservations and/or open reservations, as well as the table numbers assigned to reservations in the reservations databases 208 and to open reservations in the open reservations database 210).

In example embodiments, changes to a reservation may also be made by dragging a user interface element for a reservation 458 to another table on the screen shown in FIG. 4B. In an example embodiment, a user may drag or move a user interface element by using a finger gesture on a touch screen or by using a selection device, such as a mouse to select (for example, by clicking) and dragging the user interface element to another location. In an example embodiment, dragging a user interface element for a reservation (such as user interface element 458) automatically modifies to the table number record for the reservation in the reservations databases 208 and 258 to reflect the new table and the user interface element for the reservation 458 is then displayed in the new table.

FIG. 4C shows a “turns” view of the reservation information. This view is selected when the “turns” tab 418 is selected. The example user interface in FIG. 4C shows reservations organized in a grid 459 with each row representing a table. For example, row 460a represents table 1,row 360b represents table 2, row 360c represents table 3 and so on. In the example of FIG. 4C, rows for 25 tables are displayed. The horizontal axis of the grid 459 is organized by time as indicated at 462. Reservations are displayed as rectangular user interface elements (such as 464a and 464b) that extend across the grid horizontally corresponding to the time slot for the reservation. For example, the reservation for Juan Rodriguez is scheduled in a time slot from 5:30 to 7:30 for table 1. The user interface element for this reservation 464a is displayed as a rectangle extending from the horizontal position corresponding to 5:30 (see 467) to the horizontal position corresponding to 7:30 (see 468) in row 460a which represents table 1. The user interface element for the reservation 464a shows the start time, name and number of guests for the reservation. In other embodiments, other information may be displayed such as a phone number or other information from the reservations database or guest database. In example embodiments, user interface elements are also displayed for open reservations (see 464c). Gray highlighted rectangles (such as 464c) may be displayed across the time slot for the open reservation. For example, user interface element 464c represents an available reservation from 9:15 until 11:00 on table 1. User interface element 464c is displayed as a gray rectangle extending from the horizontal position corresponding to 9:15 (see 469) to the horizontal position corresponding to 11:00 (see 470) in row 460a which represents table 1.

In example embodiments, the user interface element for each reservation (for example, 464a or 464b) may be selected in the same manner as the user interface element for reservations shown in FIG. 4A (see 434). When a reservation is selected, a window may be displayed to show and edit the data fields for the reservation in the same manner as described in connection with window 436 in FIG. 4A. If the data field for the table 446 assigned to the reservation is changed, the user interface of FIG. 4C will automatically change the display to show the reservation in the row for the new table. For example, if reservation 464a is changed to table 5 in the example shown in FIG. 4C, it will automatically be changed so that it is displayed starting at the 5:30 time slot (see 465) in row 460e for table 5. The 5:30 time slot for table 1 (see 464a) will be changed to “Open” and a record for an open reservation in the open reservations databases 260 and 210 will be available for this table. In an example embodiment, the record in the open reservations databases 210 and 260 that represented the available reservation for Table 5 is changed to Table 1 instead. The reservation for the 5:30 time slot in table 5 (see 465) will automatically be updated to display the reservation for “Juan Rodriguez” (see 464a). The record for this reservation in the reservations databases 208 and 258 will be updated to reflect the new table number 5 instead of table 1. The display of FIG. 4C will also be automatically updated if the time slot for a reservation is changed. For example, if the time slot for reservation 464a is changed to 9:15, the reservation 464a will be moved and displayed in the time slot starting at 9:15 (see 469) in row 460a for table 1. The time slot starting at 5:30 will be marked as open. The starting or ending time for the time slot may also be modified. For example, the time slot for reservation 464a may be changed to end at 7:30, in which case the user interface element 464a will automatically be extended to the horizontal position in the grid representing the 7:30 time. The user interface elements for open reservations (such as 464c) may also be selected in a similar manner and edited. For example, the time for open reservation 464c could be moved to start at 9 instead of 9:15 in order to eliminate the unused time between the end of the prior reservation 464b and the start of the next available reservation 464c. Some time slots may also be blocked (see 466) so they are not available for a reservation or open reservation on system 100. This user interface allows restaurant staff to easily adjust both the time slots and tables for reservations and open reservations from a single user interface in order to manage the reservations and seatings in the restaurant. These changes are automatically reflected back into the affected databases 108 on the server 102 (for example, the floor plan databases 205 and 240 linking each table to a list of reservations and/or open reservations, as well as the table numbers assigned to reservations in the reservations databases 208 and to open reservations in the open reservations database 210).

In example embodiments, changes to a reservation may also be made by dragging a user interface element for a reservation 464a to another row on the screen shown in FIG. 4C to change tables or to another time on the screen shown in FIG. 4C to change the time slot. In an example embodiment, a user may drag or move a user interface element by using a finger gesture on a touch screen or by using a selection device, such as a mouse to select (for example, by clicking) and dragging the user interface element to another location. In an example embodiment, dragging a user interface element for a reservation (such as user interface element 464a) to a new row automatically modifies the table number record for the reservation in the reservations databases 208 and 258 to reflect the new table and the user interface element for the reservation 464a is then displayed in the new row. In an example embodiment, dragging a user interface element for a reservation (such as user interface element 464a) to a new time slot automatically modifies the time slot record for the reservation in the reservations databases 208 and 258 to reflect the new time slot and the user interface element for the reservation 464a is then displayed at the horizontal locations representing the new time slot. The user interface elements for reservations and open reservations (464a, 464b and 464c) may also be stretched or compressed to change the duration of the time slot. For example, if a party is running late or there is a delay in serving for reservation 464b, the time slot could be stretched to extend to 9:15 (or could be stretched longer and automatically push the 9:15 open reservation to a later time slot). Also, if reservation 464a is stretched to extend into the time slot for reservation 464b, the system 100 could automatically move reservation 464b to another table with an open reservation that can accommodate the number of guests for that reservation. These changes are automatically reflected back into the affected databases 108 on the server 102 (for example, the floor plan databases 205 and 240 linking each table to a list of reservations and/or open reservations, as well as the table numbers assigned to reservations in the reservations databases 208 and to open reservations in the open reservations database 210).

In example embodiments, reservations that have not been assigned to a time slot at a table may be shown as graphical icons or other user interface elements in a separate section of the screen (not shown in FIG. 4C). For example, the user interface in Section 4C may include an additional window or icon tray at the bottom of the screen. Graphical elements representing reservations to be assigned to a table can be displayed in that region of the screen. A user interface element for a reservation (such as user interface element 464a) may be dragged to this region which removes the table assignment from the reservation and changes the time slot on the table to open. This region of the user interface may also display icons for new reservations that have not been assigned to tables yet (as part of the process of booking the reservation by restaurant staff through the client device). When the user interface element for an unassigned reservation is selected, all of the open reservations on the “turns” view in Figure C may be automatically highlighted or otherwise graphically indicated to the user that could accommodate the reservation (for example, based on the number of guests in the party versus the capacity of a table and whether it is open at the requested time). In some embodiments, open reservations may be highlighted in different colors. For example, the table and time slot that most closely matches the requested reservation (for example, by comparing capacity and whether there will be gaps between adjacent reservations will be minimized) can be highlighted in a particular color (for example, green) while other available open reservations may be highlighted in another color (for example, yellow) to indicate alternative possibilities for placing the reservation. The restaurant staff can then drag the icon representing the requested reservation to one of the open reservation slots to place the reservation at a table. This automatically updates the reservations databases to indicate that a reservation has been assigned to that table and time slot and removes the time slot from the open reservations database for that table.

FIG. 4D shows a screen of an example user interface for displaying information about guests who have or have had reservations at a restaurant. The guest database 212 for system 100 may have information for guests at all restaurants participating in system 100. However, the guest information that may be viewed from a restaurant's account (and which may be stored in local database 262 for the restaurant) may be limited to guests who have had or have reservations for the restaurant or who have had information entered through the account for that restaurant. In some embodiments, guest information may be made available for all guests who have had reservations or who have reservations for any restaurants in a restaurant group that is managed by the account (for example, where an account is established to manage a group of affiliated restaurants). Some information may be shared among all restaurants who can view information on a guest, such as name, phone number, email address or other information entered by the guest that would be applicable to restaurants generally. Other information may be limited to a particular restaurant's accounts such as notes by the restaurant staff of a guest's preferences. The guests database 212 may include certain fields (such as restaurant notes) that are specific to each restaurant (or restaurant group) for the respective guest. In some examples, information entered by a particular restaurant instead of the guest may be stored in a restaurant specific version of the guest profile. In other examples, each restaurant may have its own version of the guest database, but data fields entered or updated by the user on the user's account may be propagated to each restaurant's guest database.

FIG. 4D shows an example user interface for displaying guest information for a particular restaurant. This user interface may be displayed by selecting the contacts tab 428a (which is an option under the guest tab 428 in this example). This user interface may also be displayed for a particular guest by selecting the guest field in another view, such as the guest field 440 in window 436 in FIG. 4A (which shows the guest for a particular reservation). The user interface of FIG. 4D shows an alphabetical list of guests 475. In this example, the entry for guest “Adam Carmel” is selected as shown at 472. The data fields from the guest database 212 and 262 for this guest may then be displayed on the right side of the screen as shown at 478. Fields showing the name 480a, phone 480b, email address 480c, spouse 480d, birthday 480e, anniversary 480f, dietary restrictions 480g, allergies 480h, and other notes 480i are displayed in this example. Each of these fields may be stored as a data field in the record for this guest in guest databases 212 and 262. These data fields may be edited by selecting button 482 and changes are saved in the guest databases 212 and 262 for the respective restaurant.

FIG. 4E shows another example user interface for displaying guest information for a particular restaurant. This user interface may be displayed by selecting the upcoming tab 428b (which is an option under the guest tab 428 in this example). This user interface shows a list of upcoming reservations for particular dates (see 484). The user may select a range of days to display. The “today” tab 486 may be used to show upcoming reservations for the current day. The list of upcoming reservations includes the names and phone numbers of the upcoming reservations as well as notices regarding special events (such as birthdays (see 486a) or anniversaries (see 486b)) for the guest or special status for the guest (such as the star shown at 486c indicating that the guest is an investor in the restaurant or other guest with special status). When a guest is selected the right side of the display 488 may show the data fields for the guest similar to FIG. 4D, which may be viewed or edited as described in connection with FIG. 4D.

FIG. 4F shows another example user interface for displaying information regarding reservations from databases 108 that may be used by restaurant staff to manage reservations, seatings and staffing. FIG. 4F is displayed by selecting the guest flow button 410. FIG. 4F shows the guest flow for a restaurant over time. The horizontal axis 490 is organized by time increments and the vertical access 492 shows the number of covers starting at that time. In this example, the time slots are shown in 15 minute increments, although other increments (such as half hour increments or other increments used to schedule reservations) may be used in other embodiments. In each 15 minute time increment, the reservations that start at that time are shown as rectangles stacked vertically (see user interface elements 494a, 494b, 494c and 494d). The vertical length of the rectangle for each reservation represents the number of guest for that reservation. The length of the vertically stacked reservations shows the total number of guests (or guest flow) for reservations starting at that time. For example, a reservation for two guests starts at 6:00 (see 494a) and two reservations for two guests (see 494c and d) start at 6:30 (for a total of 4 covers starting at 6:30). In example embodiments, the user interface element for each reservation (for example, 494a-d) may be selected in the same manner as the user interface element for reservations shown in FIG. 4A (see 434). When a reservation is selected, a window may be displayed to show and edit the data fields for the reservation in the same manner as described in connection with window 436 in FIG. 4A. If the data field for the time 444 assigned to the reservation is changed, the user interface of FIG. 4F will automatically change the display to show the reservation at the horizontal position for the new starting time (stacked vertically with other reservations starting at that time). The user interface of FIG. 4F allows restaurant staff to view the flow of guests through the restaurant over time to plan staffing, food and other aspects of the restaurant impacted by guest flow.

FIG. 5A shows another example user interface for displaying and managing reservations and seatings for a restaurant using system 100. The user interface of FIG. 5A shows a table floor plan view of the restaurant and can be displayed by selecting the “floor” tab 422 shown in FIG. 4A. The user interface shows a floor plan 502 for the restaurant including user interface elements showing the location of tables in the restaurant, such as tables 506a-f. Different rooms of the restaurant may be selected for display by selecting a room on user interface element 504. The day and time slots to be displayed may be selected using user interface elements, such as calendar 508, a button to select the current day 510 and an interface to select the time. A list of reservations is also shown at 516, showing the time, name, size and table for each reservation. As in other views described above, the user interface element for each reservation may be selected and edited. A user may also select and drag the user interface element for a particular reservation (such as 518) to the user interface element for a table (such as 506a-f) to assign the particular table to that reservation. This automatically assigns the table number to the reservation and reflects that information in the reservations databases 208 and 258. The user interface element for a reservation (such as 518) may also be selected and opened to show the data fields for that reservation. The list of reservations 516 that is displayed can be toggled by buttons 522 or tabs 524 to show upcoming reservations, seated reservations, a wait list of guests waiting to be seated or all reservations. Graphical icons 520 or other user interface elements may also be displayed to show the status of a reservation. For example, in some embodiments, different icons or user interface elements may indicate that a party has partially arrived, all arrived, or has been paged one, two or three times or that the party is seated, has been served or is on dessert, has received the check, has paid or has departed or other status. The status may automatically be recorded in the reservations database on both the client device and web server 202 as well as displayed graphically on the user interface.

FIG. 5B shows in more detail the operation of an example user interface for displaying and managing reservations and seatings for a restaurant using system 100 as described in FIG. 5A. One difficulty with the process of assignment of reservations to particular tables described in FIG. 5A is the user of the user interface may need to spend time determining which tables would properly match the criteria for the reservation, which may take away from customer service or other job responsibilities of the user. For example, the user may select and drag the user interface element for a particular reservation (such as 517) to the user interface element for a table (such as 519a-f), only to find out that the table selected would be inappropriate for according to the criteria for the reservation, such as attempting to seat a six-person party at a table for two. One option is to graphically indicate on the user interface which tables in the would meet the criteria specified in the reservation, to enable the user to more quickly and accurately determine and assign a table to the reservation. The accompanying reservation to user interface element 517 shows a reservation for five guests. Instead of requiring the user to look at the graphical icons 520 for the status of the reservation, the graphical interface can indicate to the user which tables are available. In this case, there are no tables available to seat a party of five, so none of the tables shown in FIG. 5B would be highlighted or otherwise indicated to the user.

FIG. 5C shows in more detail the operation of an example user interface for displaying and managing reservations and seatings for a restaurant using system 100 as described in FIGS. 5A and 5B. In FIG. 5C, a user may also select and drag the user interface element for a particular reservation (such as 525) to the user interface element for a eligible tables. The reservation for user interface element 525 is for two people, and in this instance all tables for which offer seating for two are graphically indicated to the user, in this case through the encircled check mark used as graphical icon on the indicated tables. The user interface for system 100 may also indicate which of the matching tables would be recommended for the user in reservation in question. This determination may be made based upon the user's dining or seating preferences stored in system 100 or obtained from outside sources, such as the user's preference to sit near the front of the restaurant or in a more secluded area for privacy. Alternatively, the determination may also take into account guidelines set forth by the restaurant, such as filling up seats in the front of the restaurant before seating parties in the rear, or seating parties based on historical or predictive models used by system 100. For example, if the restaurant is relatively empty and is not anticipated to fill during the time the party is anticipated to dine, a larger number of tables may be made available for the party in question including those with more seats than the party has guests. In this instance, the recommended table for the reservation accompanying user element 525 is table 527f as indicated by the table being shaded for easy recognition by the user. Other methods of indicating available or recommended tables may also be used, including, but not limited to highlighting or outlining the tables, using a different graphical icon to represent available or recommended tables, obscuring or not showing tables that do not match the criteria for the reservation, indicating with arrows or dotted lines the intended path to assign the available or recommended table to .the particular reservation, or others.

FIG. 5D shows additional windows 530 and 532 that may be displayed when a reservation is selected from list 516 (or from other views showing user interface elements for reservations in application 240). Window 530 shows data fields for the reservation similar to window 436 in FIG. 4A. Each of these fields may be edited and saved in a manner similar to that described in connection with FIG. 4A. FIG. 5D also shows an example window 532 that can be displayed when the status data field 548 is selected. As shown in window 532 options for changing the status of the reservation may be displayed such as cancel/no show, expected or in-house. For guests that have arrived in-house, the status may further indicate that the party has partially arrived, all arrived, or have been paged one, two or three times. The reservation status may also be changed to indicate that the party has been seated. The status may be saved back into the reservations databases 208 and 258 and also result in a change of icons displayed on the user interface shown in FIG. 5A to indicate the status of the reservation and/or table. Window 530 also includes a user interface element such as button 534 to seat the reservation. When the “seat me” button 534 is selected, the reservation status is changed to seated at the table 546 assigned to the reservation.

FIG. 5E shows an additional window 550 that may be displayed when the user interface element for a table (such as 536a) is selected. Window 550 may display and permit the user to edit any of the data fields associated with a table in databases 108. In the example of FIG. 5E, window 550 includes a list of upcoming reservations for the table 552. As in other views, any of the reservations may be selected (for example to open a window such as window 436 or 530) and edited. Window 550 also displays a data field identifying the server for the table 554 and options for updating the status of the table 556 (such as unseating a reservation, blocking the table for a specified period of time (resulting in a blocked time slot as shown at 466 in FIG. 4E) or linking the table to another table to seat a larger party or make available a larger reservation as an option when both tables are open. When tables are linked, system 100 may make available open reservations for larger parties using both tables when both tables are available and may also make reservations available for smaller parties using the tables separately.

In example embodiments, the client device may be an iPad or other tablet or smartphone with a multi-touch user interface. In this example, multi-touch finger gestures (for example spreading two fingers apart or squeezing them together on the touch screen) may be used to zoom in or out all or part of the display for a screen of the user interface. In some example embodiments, the whole display may zoom in or out. In other embodiments, only the selected user interface elements (such as the floor plan) may be zoomed in or out. In some example embodiments, all of the user interface elements on the screen are active elements, which means that clicking on them brings up additional information or jumps to other views. In example embodiments, the user interface elements for reservations and tables may be selected by the user by using a mouse click, tapping the touch screen or other selection indicia. In response, the user interface may display a window with additional information about the reservation or table as described above. These user interface elements may also be selected and dragged to other time slots or tables as described above. In example embodiments, these actions on the user interface automatically update the corresponding data fields for the reservation or table in the databases described above.

All of the information made available through the application user interface in FIGS. 4A to 4F and in FIGS. 5A to 5E may also be made available through a web interface to the server 102 which may be accessed through a browser on client devices.

FIG. 5F shows an example user interface for restaurant management using a web interface according to an example embodiment. As shown in FIG. 5F, tabs 570 may be used to select different pages for managing restaurant information, configuring information for dynamic pricing and capacity planning and making and modifying reservations. For example, a “restaurant” page (see tab 570a) may be included with a user interface for viewing, entering and editing data in the restaurant profiles databases 214 and 264, such as restaurant name, description, address and other restaurant profile information as described above. A “guestbook” page (see tab 570c) may be included with an interface for viewing, entering and editing data in the guest databases 212 and 262, such as name, phone, address, birthday, dietary restrictions and other guest information as described above. A “user management” page (see tab 5700 may be included with an interface for viewing, entering and editing data defining groups of affiliated restaurants that can be managed under a single account, user accounts for restaurant staff and management permitted to access all or part of the management interface for the restaurant's account (whether through the client device interface or web interface), access privileges and other user configuration information for the account. For example, the front of house staff may have access to view, edit and revise reservations at a particular restaurant, but may not be have access to view information for other restaurants in the restaurant group and may not have access to view or edit parameters used for dynamic pricing of reservations. A manager of a restaurant may be able to view, enter and edit parameters used for dynamic pricing of reservations for a particular restaurant, but not other restaurants in the group. On the other hand, a general manager of the restaurant group may have access privileges for each of the restaurants in the group. In example embodiments, access privileges may be established for each user permitted to access the account and the privileges may define whether the user can view, enter and/or edit any of the data fields or categories of data fields in any of the databases 108 or through any of the user interfaces of the system.

The example restaurant management interface may also include a page for viewing, entering and editing reservations as shown in FIG. 5F. In example embodiments, reservations may be added, revised or deleted through this page or through the client interface. The changes are stored in the reservations databases 208 and 258 on both the server and client device. As described above, consumers 204 may also book reservations through web server 202 which are also reflected in the reservations databases 208 and 258. The web server 202 manages and synchronizes reservations placed or modified by restaurant staff through the restaurant management account as well as reservations made by consumers through web server 202.

The example restaurant management interface may also include a page for configuring the floor plan for the restaurant as shown in FIG. 5G. This interface allows graphical representations of the tables to be placed on the floor plan and the data for the floor plan databases 205 and 240 to be viewed, entered and edited, such as the minimum and maximum capacity for each table. In example embodiments, the data entered through this interface is used to configure the floor plan view described above in connection with FIGS. 5A-5E.

The example restaurant management interface may also include pages for entering parameters and rules to be used by the system 100 for dynamic pricing of reservations. For example, a page may be included to specify which reservations (for example, by days/times, available capacity, days until the reservation or other parameters described above) may require a payment and what minimum and maximum amounts may be charged by system 100. The system may then dynamically price reservations within the established parameters based on actual or historical demand or other data as described above.

In addition, pages may be included for viewing, entering and revising data to be used by system 100 for dynamic capacity planning. For example, FIG. 5H shows an example interface for entering the turn times (the expected time that a reservation will fill) based on the number of covers. This data can then be used to determine the time slots to be included in reservations databases 208 and 258 for reservations to be made available through the system 100. In example embodiments, restaurants may also be able to configure data indicating the number of parties and number of guests that may be seated during each time interval (for example, for each 15 minute increment). System 100 can use this information to dynamically generate the reservations to be made available at each time. As reservations are booked, the starting time for remaining reservations may be dynamically changed by the system to manage the flow of guests based on the parameters set by the restaurant and/or parameters determined by the system as described above. If reservations that have been booked would leave a gap before the start of an available reservation, the system may automatically adjust the start time for a subsequent reservation in the open reservations databases 210 and 260 or change table assignments (or propose changes in table assignments) to reduce gaps in the schedule. In addition, the system may automatically adjust start times made available to consumers through web server 202 to stagger start times more evenly dynamically based on reservations that are being made through the system.

The above restaurant management interfaces are examples only and other embodiments may use other interfaces. The data and parameters entered through restaurant management interfaces (whether through the web or client devices, APIs or other interfaces) may be combined with data collected by the system from consumers, through POS integration or other interfaces. The system may collect historical and real-time data regarding reservations, turn times (including, for example, estimated, average and actual times for particular consumers), demand for reservations (including, for example, historical demand and actual demand based on reservations made for an upcoming day/time), individual customer purchases and preferences and other data. Any of this data, in turn, can be used to establish parameters for rules to determine dynamic pricing and/or discounts for reservations or for rules for dynamic capacity management for restaurants. For example, consumers who have historically been repeat customers or spent large amounts on meals or purchased expensive wine or that have other data meeting a threshold or other criteria for a rule may receive priority on open reservations or may always be offered reservations without a fee or at a discount regardless of demand. The data may also be searched and filtered based on any of the data fields for data mining and restaurant planning purposes. In example embodiments, the system may also create aggregated benchmark data across restaurants or categories or groups of restaurants that can be used to compare against data for a particular restaurant. For example, demand data (whether the restaurant is filled, how far in advance it fills, how many requests are made after it has filled, or other demand related data) may be average across any group or category of restaurants. This data can then be made available through the restaurant management database as a benchmark and the corresponding demand data for the individual restaurant can be generated and displayed against the benchmark for comparison purposes in example embodiments.

Example computer system and network architectures that may be used in connection with example embodiments will now be described. In example embodiments, the software on the server and client device for displaying user interfaces, managing the databases, performing searches, booking reservations, charging and allocating payments and performing the other processing describe above may comprise software program modules executed by the server or client computer system. Example embodiments may include a computer system having at least one processor, at least one memory, and at least one program module, the program module stored in the memory and configured to be executed by the processor, wherein the at least one program module includes instructions for performing one or more of the features described above. In another example embodiment, a computer readable medium is provided with executable instructions for performing one or more of the features described above.

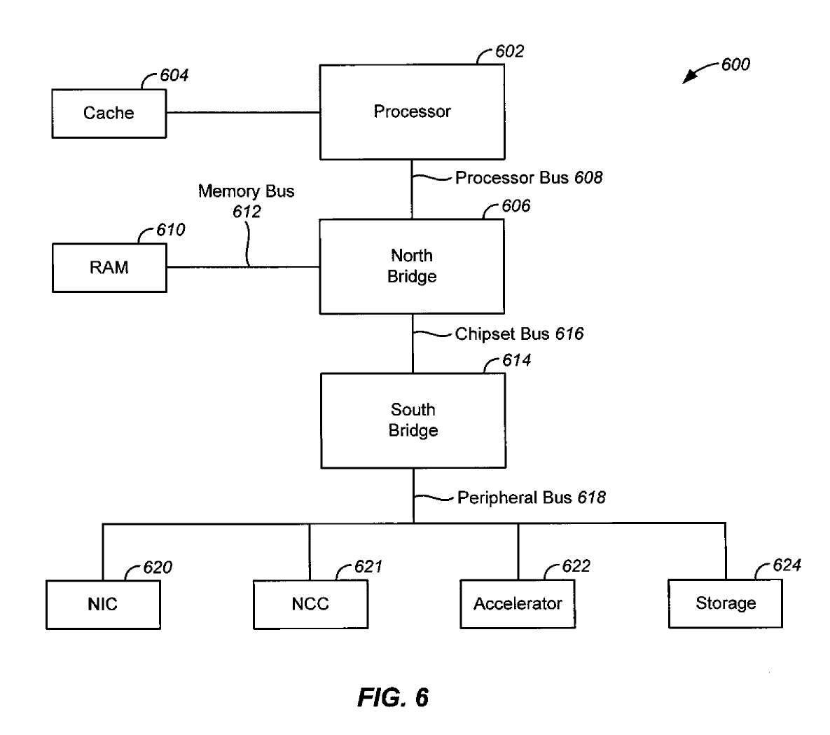

FIG. 6 is a block diagram showing an example architecture of a computer system 600 that may be used in connection with example embodiments of the present invention. This example architecture may be used for one or more server systems or client devices used in connection with example embodiments. This computer architecture is an example only and other computer architectures may be used in example embodiments. For example, server computer systems available from Dell, Hewlett-Packard (HP) or IBM may be used in connection with example embodiments. In example embodiments, client devices used in connection with example embodiments may include personal computers available from Dell or HP or tablet computers, personal digital assistants (PDAs) and other mobile computing devices such as the iPad or iPhone available from Apple Computer, Inc. and Android-based mobile devices available from Motorola, Samsung and other vendors. In example embodiments, the user interface may be displayed using browser software or application software on the client device. A mouse, touch screen, keyboard or other selection device on the client may be used to interact with the user interface.

As shown in FIG. 6, an example computer system may include a processor 602 for processing instructions. Multiple threads of execution may be used for parallel processing. In some embodiments, multiple processors or processors with multiple cores may also be used, whether in a single computer system, in a cluster or distributed across systems over a network.

As shown in FIG. 6, a high speed cache 604 may be connected to, or incorporated in, the processor 602 to provide a high speed memory for instructions or data that have been recently, or are frequently, used by processor 602. The processor 602 is connected to a north bridge 606 by a processor bus 608. The north bridge 606 is connected to random access memory (RAM) 610 by a memory bus 612 and manages access to the RAM 610 by the processor 602. The north bridge 606 is also connected to a south bridge 614 by a chipset bus 616. The south bridge 614 is, in turn, connected to a peripheral bus 618. The peripheral bus may be, for example, PCI, PCI-X, PCI Express or other peripheral bus. The north bridge and south bridge are often referred to as a processor chipset and manage data transfer between the processor, RAM and peripheral components on the peripheral bus 618. In some alternative example architectures, the functionality of the north bridge may be incorporated into the processor instead of using a separate north bridge chip.

Software and data are stored in external storage 624 and may be loaded into RAM 610 and/or cache 604 for use by the processor. The system 600 includes an operating system for managing system resources, such as Linux or other operating system, as well as application software running on top of the operating system in accordance with example embodiments of the present invention.

In this example, system 600 also includes network interface cards (NICs) 620 and 621 connected to the peripheral bus for providing network interfaces to external storage and other computer systems and networks that can be used for distributed parallel processing, data retrieval and searching and transmission and receipt of communications between server and client devices.

The depicted example in FIG. 6 and above-described examples are not meant to imply architectural limitations and are examples only.

While the invention has been described with reference to the example embodiments set forth above, those skilled in the art will be able to make various modifications to the described embodiments of the invention without departing from the spirit and scope of the invention. For example, in some embodiments, the system 100 may also be used to search and make reservations for nightclubs, entertainment venues and other events in addition to or alternatively to restaurant reservations. Payments may be charged or discounts provided for reservations in the same manner as described above, including pricing or discounts based, at least in part, on data regarding estimated demand (which may be based, at least in part, on current demand and historical demand for the event or venue). These reservations for other venues and events may also be subject to bumping as described above and have a management interface for changing the status of the reservation at the time of fulfillment. Data may be collected through the management interface regarding fulfillment of the reservation for these venues or events and used to determine status, benefits, incentives and pricing for the user in the future and for current or future capacity planning and management for the venue or event. Payment processing may also be provided during fulfillment of the reservation for these venues or events. Accordingly, the description of example embodiments above is not meant to limit the scope of the invention.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. A method comprising:
receiving open reservation data regarding available reservations for a plurality of restaurants;
receiving a search request from a user;
determining a subset of the available reservations matching the search request, the determining being performed by a processor of a machine based, at least in part, on the open reservation data;
receiving a request from a user to make a reservation corresponding at least one of the available reservation matching the search request;
storing data indicating that the requested reservation is assigned to the user;
receiving a request or offer from another user to have the requested reservation transferred to the other user;
offering a benefit or incentive to the user to permit the requested reservation transferred to the other user;
receiving an acceptance or approval from the user to have the requested reservation to be transferred to the other user;
receiving payment information from the other user;
arranging for a price to be charged to the other user for having the requested reservation transferred using the payment information from the other user; and
arranging for the benefit or incentive to be provided to the user.

56. The method of claim 55, wherein the benefit or incentive provided to the user includes a payment, credit or discount of a variable amount based, at least in part, on the price charged to the other user.

57. The method of claim 55, wherein the benefit or incentive provided to the user includes a payment, credit or discount to be applied against a menu item or meal at the restaurant for which the reservation was made.

58. The method of claim 55, further comprising notifying the restaurant that the reservation has been transferred to the other user.

59. The method of claim 55, further comprising arranging for a benefit to be provided to the restaurant based, at least in part, on the payment made for the transfer of the reservation.

60. The method of claim 55, wherein the benefit to the restaurant is a payment of a variable amount based, at least in part, on the amount of the payment made for the transfer of the reservation.

61. The method of claim 55, wherein the benefit to the restaurant is a payment that includes a fixed component independent of the amount of the payment made for the transfer of the reservation.

62. The method of claim 55, wherein the benefit to the restaurant is a payment that includes a fixed component independent of the amount of the payment made for the transfer of the reservation and a variable amount based, at least in part, on the amount of the payment made for the transfer of the reservation.

63. The method of claim 55, wherein the benefit to the restaurant is a payment based, at least in part, on a variable amount dependent on the amount of the payment made for the transfer of the reservation and a fixed amount retained by a service provider.

64. A method comprising:
receiving open reservation data regarding available reservations for a plurality of restaurants;
receiving a search request from a user;
receiving payment information from the user;
determining a subset of the available reservations matching the search request, the determining being performed by a processor of a machine based, at least in part, on the open reservation data;
receiving a request from a user to make a reservation corresponding to at least one of the available reservations matching the search request;
storing data indicating that the requested reservation is assigned to the user;
receiving a change in status for the reservation during fulfillment of the reservation;
receiving data regarding items ordered or provided during fulfillment of the reservation; and
providing the data regarding items ordered or provided during fulfillment of the reservation for display to the consumer on a mobile device during fulfillment of the reservation.

65. The method of claim 64, further comprising providing pricing or billing information for display to the user on a mobile device during fulfillment of the reservation.

66. The method of claim 64, further comprising receiving tip information from the user via a mobile device during fulfillment of the reservation.

67. The method of claim 61, further comprising receiving payment authorization from the user via a mobile device during fulfillment of the reservation.

68. (canceled)

69. The method of claim 64, further comprising arranging for the payment amount to be charged using the payment information provided by the user.

70. The method of claim 64, further comprising receiving requests or orders from the user during fulfillment of the reservation via a mobile device.

71. The method of claim 70 further comprising providing notices, alerts or order information to the restaurant.

72. The method of claim 64 wherein the data regarding items ordered or provided includes data provided through a restaurant management interface by restaurant staff.

73. The method of claim 64 wherein the notices, alerts or order information from the user is provided for display to restaurant staff on a restaurant management interface on a client device.

74. The method of claim 64 wherein the client device is a tablet computer with a touchscreen interface.

75. (canceled)

76. (canceled)

77. (canceled)

78. (canceled)

79. (canceled)

80. (canceled)

81. (canceled)

82. (canceled)

83. (canceled)

84. A computer-program product for use in conjunction with a computer system, the computer-program product comprising a computer-readable storage medium and a computer-program mechanism embedded therein, the computer-program mechanism including:
instructions for receiving open reservation data regarding available reservations for a plurality of restaurants;
instructions for receiving a search request from a user;
instructions for receiving payment information from the user;
instructions for determining a subset of the available reservations matching the search request based, at least in part, on the open reservation data;
instructions for receiving a request from a user to make a reservation corresponding the at least one available reservation for which the price is determined;
instructions for storing data indicating that the requested reservation is assigned to the user;
instructions for receiving a change in status for the reservation during fulfillment of the reservation;
instructions for receiving data regarding items ordered or provided during fulfillment of the reservation;
instructions for storing providing the data regarding items ordered or provided during fulfillment of the reservation for display to the consumer on a mobile device during fulfillment of the reservation is assigned to the user.

85. (canceled)

86. (canceled)

87. (canceled)
